(19) United States
(12) Patent Application Publication
(10) Pub. No.: US 2008/0181612 A1
(43) Pub. Date: Jul. 31, 2008

(54) Method and system for wavelength division multiplex optical signal combining

(75) Inventors: John Mills, Ottawa (CA); Ahmad Atieh, Ottawa (CA); Suet Yuen, Kanata (CA)

Correspondence Address: SMART & BIGGAR;P.O. BOX 2999, STATION D, 900-55 METCALFE STREET, OTTAWA, ON, K1P5Y6, omitted

(73) Assignee: BTI PHOTONIC SYSTEMS INC.

(21) Appl. No.: 11/698,839

(22) Filed: Jan. 29, 2007

(51) Int. Cl. H04J 14/02

(52) U.S. Cl. 398/83

(57) ABSTRACT

A selective WDM add-channel system and method for adding channels to a WDM (wavelength division multiplexed) signal input to produce a WDM signal output while protecting against signal collisions are provided. The method protects against signal collisions by determining channel wavelengths of add-channel signals and at least one of the WDM signal input and the WDM signal output to ensure that channels that are added to the WDM signal input have different channel wavelength than each other and the channels that are already part of the WDM signal input. The selective WDM add-channel system comprises a selective combiner and a controller and is operable to selectively combine a plurality of add-channel inputs with a WDM input signal to produce a WDM output signal based on the channel wavelengths of the add-channel input signals and at least one of the WDM input signal and the WDM output signal.

### FIELD OF THE INVENTION

The invention pertains to the field of optical signal combining, and more particularly to optical add-drop multiplexing.

### BACKGROUND OF THE INVENTION

Wavelength division multiplexing (WDM) increases the capacity of an individual optical link by dividing the available bandwidth into separate channels and transmitting data on each of the channels simultaneously. The channels are allocated a specific portion of the available bandwidth, i.e. a range of allowable wavelengths that data on a specific channel may be transmitted on, and are separated by a specific channel spacing so that data on one channel (i.e. at one channel wavelength) will not interfere with data on a second channel (i.e. at a second channel wavelength).

In order to manage the use of all of the available channels in a WDM optical signal, optical networks incorporate optical add-drop multiplexers in optical nodes throughout the network so that data may be dropped or “added” at a given node.

In existing add-drop multiplexers, adding a channel to an existing WDM optical signal involves simply multiplexing the channel that is to be added with the other channels of the WDM optical signal.

Existing optical add-drop multiplexers leave it up to an operator, such as a field technician, to manage the adding and dropping of channels.

### SUMMARY OF THE INVENTION

According to one aspect of the present invention, there is provided a method comprising: determining a respective channel wavelength for each one of a plurality of add-channel input signals; determining channel wavelengths of a WDM (wavelength division multiplex) input signal; and selectively combining the plurality of add-channel input signals with the WDM input signal to produce a WDM output signal by, for each add-channel input signal:

a) blocking the add-channel input signal if the channel wavelength of the add-channel input signal is at least one of:
i) the same as the channel wavelength of any of the other add-channel input signals; and
ii) the same as any of the channel wavelengths of the WDM input signal; and

b) combining the add-channel input signal with the WDM input signal if the channel wavelength of the add-channel input signal is different than the channel wavelengths of the other add-channel input signals and the WDM input signal.

In some implementations, determining the channel wavelengths of the WDM signal comprises: determining channel wavelengths of the WDM output signal; and determining the channel wavelengths of the WDM input signal from the channel wavelengths of the WDM output signal.

In some implementations, selectively combining the add-channel input signals with the WDM input signal to produce the WDM output signal comprises: selectively combining the add-channel input signals to produce a WDM add signal; and combining the WDM add signal with the WDM input signal to produce the WDM output signal; wherein selectively combining the add-channel input signals to produce the WDM add signal comprises:

for each add-channel input signal:

a) blocking the add-channel input signal from being added to the WDM add signal if the channel wavelength of the add-channel input signal is at least one of:
i) the same as the channel wavelength of any of the other add-channel input signals; and
ii) the same as any of the channel wavelengths of the WDM input signal; and

b) adding the add-channel input signal to the WDM add signal if the channel wavelength of the add-channel input signal is different than the channel wavelengths of the other add-channel input signals and the WDM input signal.

In some implementations, the method further comprises at least one of amplifying and gain flattening the WDM add signal.

In some implementations, the method further comprises: determining channel power levels of the plurality of add-channel input signals; and wherein combining the add-channel input signal with the WDM input signal further comprises adjusting the channel power level of the add-channel input signal to be substantially equal to a desired channel power level.

In some implementations, the method further comprises determining the channel power levels of the WDM input signal and wherein the desired channel power level is equal to the channel power levels of the WDM input signal.

In some implementations, blocking the add-channel input signal from being combined with the WDM input signal comprises attenuating the add-channel input signal.

In some implementations, determining the channel wavelengths of the plurality of add-channel input signals comprises switching the add-channel input signals from first signal paths on which the add-channel input signals are any one of blocked and combined with the WDM input signal to second signal paths on which the channel wavelengths of the add-channel input signals are determined.

According to another broad aspect of the present invention, there is provided a selective combiner system comprising: a plurality of add-channel inputs each operable to receive a respective one of a plurality of add-channel input signals; a channel wavelength determiner operable to determine a respective channel wavelength for each of the plurality of add-channel input signals, and to determine channel wavelengths of a WDM signal with which the add-channel input signals are to be combined; a selective combiner that for each add-channel input signal blocks the add-channel input signal or combines the add-channel input signal with the WDM signal; and control logic functionally connected to control combining and blocking performed by the selective combiner so as to prevent adding multiple add-channel input signals having the same channel wavelength as each other, and so as to prevent adding an add-channel input signal having the same channel wavelength as any channel wavelength already present in the WDM signal.

In some implementations, the selective combiner system comprises: a WDM input operable to receive a WDM input signal as said WDM signal; the channel wavelength determiner operable to determine the channel wavelengths of the WDM signal with which the add-channel input signals are to be combined by processing the WDM input signal.

In some implementations, the selective combiner system comprises: a WDM input operable to receive a WDM input signal as said WDM signal; a WDM output operable to transmit a WDM output signal; the channel wavelength determiner operable to determine the channel wavelengths of the WDM signal by processing the WDM output signal.

In some implementations, the selective combiner comprises a respective VOA for each add-channel input that performs said combining or blocking of the respective add-channel input signal.

In some implementations, the channel wavelength determiner comprises: a respective OCM for each add-channel input; an OCM for the WDM input signal.

In some implementations, the channel wavelength determiner comprises: a respective OCM for each add-channel input; an OCM for the WDM output signal.

In some implementations, the selective combiner comprises: a first combiner that produces a WDM add signal that is a combination of add-channel signals that are not blocked; a second combiner that combines the WDM add signal with the WDM signal to produce a combined WDM signal.

In some implementations, the first combiner comprises a fiber coupler cascade combiner.

In some-implementations, the second combiner comprises a fiber coupler.

In some implementations, the selective combiner system further comprises: an amplifier connected between the first combiner and the second combiner.

In some implementations, the amplifier comprises any one of an EDFA, an SOA and a Raman amplifier.

In some implementations, the selective combiner system further comprises:,a gain flattening element connected between the first combiner and the second combiner.

In some implementations, the selective combiner system further comprises: a respective 1×2 switch for each add-channel input operable to switch the respective add-channel input signal between the selective combiner and the channel wavelength determiner.

In some implementations, the channel wavelength determiner comprises: a first OCM for the combined WDM signal; and a second OCM for the WDM signal.

In some implementations, the second combiner is operable to pass at least a portion of the combined WDM signal to the first OCM.

In some implementations, the selective combiner system further comprises: a switch operable to: switch the WDM add signal between the second combiner and the channel wavelength determiner; and switch at least a portion of the WDM signal between the second combiner and the channel wavelength determiner.

In some implementations, the channel wavelength determiner comprises an OCM.

In some implementations, the channel wavelength determiner comprises: a combiner operable to combine the respective add-channel input signals switched to the channel wavelength determiner to produce a combined output; a first OCM for the combined output; and a second OCM for the WDM signal.

In some implementations, the selective combiner system further comprises: a WDM input operable to receive a WDM input signal as said WDM signal; a WDM output operable to transmit a WDM output signal comprising a combination of add-channel input signals that are not blocked and the WDM signal; wherein the channel wavelength determiner further comprises: a 2×1 switch operable to switch any one of at least a portion of the WDM input signal; and at least a portion of the WDM output signal, to the second OCM at a time.

In some implementations, the selective combiner system further comprises: a WDM input operable to receive a WDM input signal as said WDM signal; a WDM output operable to transmit a WDM output signal comprising a combination of add-channel input signals that are not blocked and the WDM signal; wherein the channel wavelength determiner comprises: an OCM; a combiner operable to combine the respective add-channel input signals switched to the channel wavelength determiner to produce a combined output; and a 3×1 switch operable to switch any one of at least a portion of the combined output; at least a portion of the WDM input signal; and at least a portion of the WDM output signal, to the OCM at a time.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying diagrams, in which:

FIG. 1 is a block diagram of a selective WDM add-channel system in accordance with an embodiment of the invention;

FIG. 2 is a flow chart of a method for protecting against signal collisions while adding channels to a WDM input in accordance with an embodiment of the invention;

FIG. 3 is a flow chart of a method for controlling a selective combiner in accordance with an embodiment of the invention;

FIG. 4 is a block diagram of a selective WDM add-channel system in accordance with an embodiment of the invention;

FIG. 5 is a block diagram of a selective WDM add-channel system in accordance with an embodiment of the invention;

FIG. 6 is a block diagram of a selective WDM add-channel system in accordance with an embodiment of the invention;

FIG. 7 is a block diagram of a selective WDM add-channel system in accordance with an embodiment of the invention;

FIG. 8 is a block diagram of a selective WDM add-channel system in accordance with an embodiment of the invention;

FIG. 9 is a block diagram of a selective WDM add-channel system in accordance with an embodiment of the invention;

FIG. 10 is a block diagram of a selective WDM add-channel system in accordance with an embodiment of the invention; and

FIG. 11 is a block diagram of a selective WDM add-channel system in accordance with an embodiment of the invention.

### DETAILED DESCRIPTION

A signal collision occurs in a WDM optical signal when two or more optical signals with the same channel wavelength, i.e. signals with wavelengths that are closer than dictated by the minimum channel spacing, are transmitted on the same fiber or other transmission medium. When adding one or more add-channel optical signals to a WDM optical signal containing one or more channels at different channel wavelengths using an optical ADM (add-drop multiplexer), two or more add-channel input signals with the same channel wavelength should not be added because they will collide with each other. Furthermore, one or more add-channel input signals which are to be added should not have channel wavelengths which are substantially equal to any of the channel wavelengths of the channels that are already part of the WDM optical signal as that will also result in signal collisions. However, mistakes can be made. Such mistakes might, for example, be caused by a technician plugging an incorrect or factory mislabelled signal source into an add-channel input of an ADM. Unfortunately, existing ADM implementations fail to protect against signal collisions caused by such mistakes.

Various methods and systems to perform add-channel interrogation and signal collision protection are provided. The methods and systems determine channel wavelengths of add-channel input signals and compare them to each other and to the channel wavelengths of the channels of the WDM input signal that they are to be added to in order to ensure that add-channel input signals with the same channel wavelength as each other, or with the same channel wavelength as one of the channels of the WDM input signal are blocked rather than added to the WDM input signal.

The systems and methods described below have the advantage that they protect against signal collisions caused by user error.

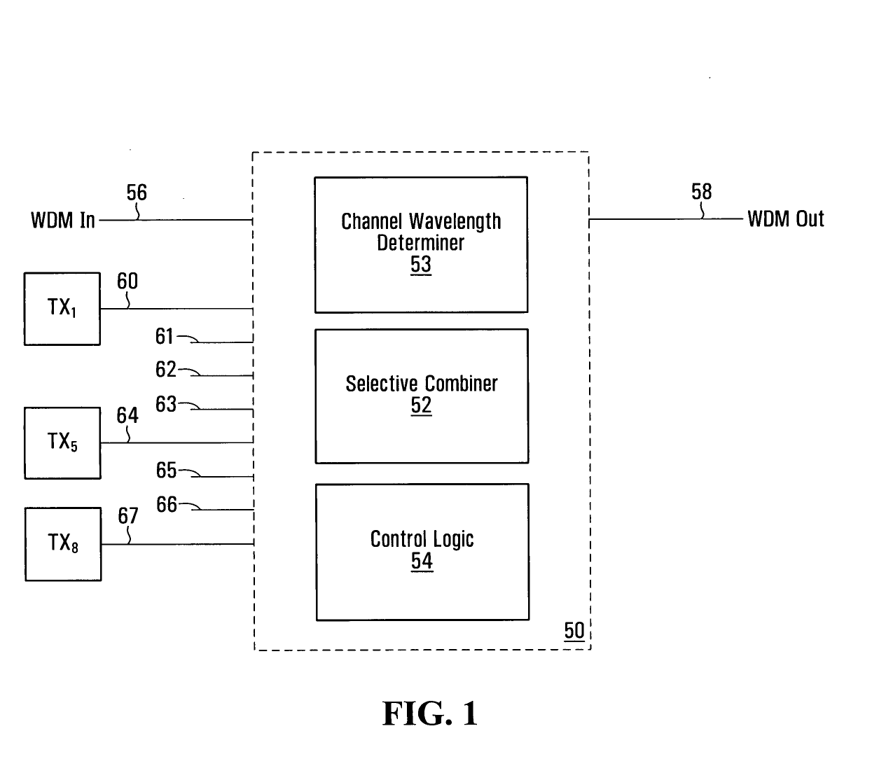

FIG. 1 is a block diagram of an example of a selective WDM add-channel system 50 in accordance with an embodiment of the invention. The selective WDM add-channel system 50 has a WDM input 56, a WDM output 58 and eight add-channel inputs 60-67. Each add-channel input 60-67 can be connected to a signal transmitter. The number of signal transmitters connected to the selective WDM add-channel system 50 will change over time as modifications to a network are made. At the instant depicted, there are three connected signal transmitters TX₁, TX₅ and TX₈ connected to add-channel inputs 60, 64 and 67 respectively. The selective WDM add-channel system 50 includes a channel wavelength determiner 53, a selective combiner 52 and control logic 54.

In operation, the channel wavelength determiner 53 determines the channel wavelengths of add-channel input signals which are input to any of the add-channel inputs 60-67. At the instant depicted, this would include the signals transmitted by the three transmitters TX₁, TX₅ and TX₈, which are received at the three add-channel inputs 60, 64 and 67 respectively. The channel wavelength determiner 53 also determines channel wavelengths of a WDM input signal received at the WDM input 56. The channel wavelength determiner 53 communicates information indicating the channel wavelengths present in the three add-channel input signals and the channel wavelengths present in the WDM input signal to the control logic 54.

In some implementations, the information indicating the channel wavelengths present in add-channel signals and the channel wavelengths present in a WDM input signal includes power level information of each channel wavelength present in the add-channel signals and in the WDM input signal.

The control logic block 54 controls the selective combiner such that for each add-channel input signal:

a) the add-channel input signal is blocked if the channel wavelength of the add-channel input signal is at least one of:
i) the same as the channel wavelength of any of the other add-channel input signals; and
ii) the same as any of the channel wavelengths of the WDM input signal; and

b) the add-channel input signal is combined with the WDM input signal if the channel wavelength of the add-channel input signal is different than the channel wavelengths of the other add-channel input signals and the WDM input signal.

In some implementations, channel drop functionality is also provided as part of the selective combiner system. This allows wavelength channels to be dropped from an incoming WDM signal. From the perspective of the embodiments discussed herein, so long as the wavelength channel dropping occurs prior to the measurement of the WDM signal to which channels are to be added, there is basically no change to the subsequent operation For example, if a channel has been dropped (by the wavelength dropping functionality, not shown) from a WDM signal prior to applying the WDM signal to the WDM input 56 of the selective combiner system 50 and therefore an add-channel input signal with the same channel wavelength as the dropped channel may be added for channel wavelength reuse. If more than one channel has been dropped from the WDM signal then more than one add-channel signal with respective channel wavelengths equal to the respective channel wavelengths of the dropped channels may be added.

In some embodiments, the selective combiner 52 includes a first combiner that selectively combines the plurality of add-channel input signals to produce a WDM add signal and a second combiner that combines the WDM add signal with the WDM input signal. In these embodiments, the control logic block 54 controls the selective combiner such that for each add-channel input signal:

a) the add-channel input signal is blocked from being added to the WDM add signal if the channel wavelength of the add-channel input signal is at least one of:
i) the same as the channel wavelength of any of the other add-channel input signals; and
ii) the same as any of the channel wavelengths of the WDM input signal; and

b) the add-channel input signal is added to the WDM add signal if the channel wavelength of the add-channel input signal is different than the channel wavelengths of the other add-channel input signals and the WDM input signal.

While the selective WDM add-channel system 50 is shown as having eight add-channel inputs 60-67, more generally a selective WDM add-channel system may have any number of add-channel inputs, for example, 16 or 48.

In some implementations, an optical amplifier such as an erbium doped fiber amplifier, a semiconductor optical amplifier or a Raman amplifier is connected in the signal path of the WDM add signal between the first combiner and the second combiner and is used to amplify and/or gain flatten the WDM add signal.

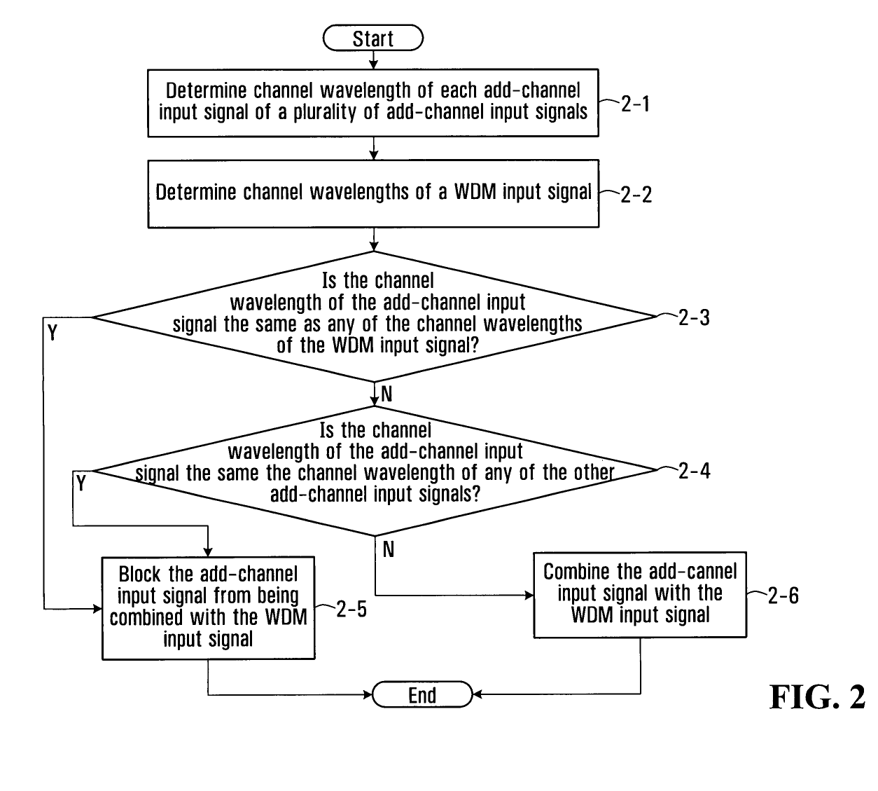

FIG. 2 is a flow chart of an example of a method of protecting against signal collision in a selective WDM add-channel system operable to selectively combine a plurality of add-channel input signals with a WDM input signal to produce a WDM output signal. The selective WDM add-channel system may, for example, be implemented as the add subsystem of a ROADM (re-configurable optical add-drop multiplexer), in which case the WDM input signal may be the express optical signal or the through optical signal of the ROADM. The method protects against signal collision by determining the channel wavelengths of the add-channel input signals and the WDM input signal of the a selective WDM add-channel system to ensure that an add-channel input signal with the same channel wavelength as one of the other add-channel input signals or the same channel wavelength as one of the channels of the WDM input signal is not combined with the WDM input signal.

The method begins at step 2-1 in which channel wavelengths of the plurality of add-channel input signals are determined. In step 2-2, the channel wavelengths of the WDM input signal are determined. In step 2-3, if it is determined that the channel wavelength of the add-channel input signal is the same as any of the channel wavelengths of the WDM input signal, then the method proceeds to step 2-5 (yes path), otherwise, the method proceeds to step 2-4 (no path). In step 2-4, if it is determined that the channel wavelength of the add-channel input signal is the same as the channel wavelength of any of the other add-channel input signals, the method proceeds to step 2-5 (yes path), otherwise the method proceeds to step 2-6 (no path). In step 2-5 the add-channel input signal is blocked from being combined with the WDM input signal. In step 2-6, the add-channel input signal is combined with the WDM input signal.

The net effect of the method is that an add-channel optical signal is only combined with the WDM input signal if the channel wavelength of the add-channel input signal is different than the channel wavelengths of the other add-channel input signals and the WDM input signal.

The flow chart shown in FIG. 2, of the example method of protecting against signal collision in a selective WDM add-channel system, is merely exemplary. The steps of the methods may be re-ordered and/or steps may be added or removed. For example, in some implementations, the step of determining the channel wavelengths of the WDM input signal is performed before the step of determining the channel wavelength of each add-channel input signal.

In some implementations, power levels of the plurality of add-channel input signals and the WDM input signal are determined in order to determine which channels are present and at what power level.

In some implementations, the channel wavelengths of the WDM output signal are determined as well as or in place of the channel wavelengths of the WDM input signal.

In some implementations, when a new add-channel input signal has the same channel wavelength as another add-channel input signal that has already been combined with the WDM input signal, the new add-channel input signal is blocked from being combined with the WDM input signal, while the another add-channel input signal continues to be combined with the add-channel input signal.

In some implementations, blocking the add-channel input signal from being combined with the WDM input signal includes at least one of attenuating the add-channel input signal and switching the add-channel input signal to a signal path on which the add-channel input signal will not be combined with the WDM input signal.

In some implementations, combining the add-channel input signal with the WDM input signal is done by first combining the add-channel input signal with other add-channel-input signals, which are also to be combined with the WDM input signal, to produce a WDM add signal and then combining the WDM add signal with the WDM input signal.

In some implementations, determining the channel wavelength of an add-channel input signal is done indirectly by combining the add-channel input signals to produce a WDM add signal and then measuring the wavelengths of the WDM add signal.

In some implementations, determining the channel wavelength of an add-channel input signal includes switching the add-channel input signal from a first signal path on which the add-channel input signal is any one of blocked and combined with the WDM input signal to a second signal path on which the channel wavelength of the add-channel input signal is determined.

In some implementations, the power levels of the add-channel input signals are adjusted before being combined with the WDM input signal such that the method is lossless.

In some implementations, the power levels of the add-channel input signals are individually adjusted before being combined with the WDM input signal.

In some implementations, the power level of an add-channel input signal is individually adjusted by at least one of attenuating and amplifying the add-channel input signal.

In some implementations, the power level of an add-channel input signal is adjusted to a desired level substantially equal to power levels of the channels included in the WDM input signal.

In some implementations, the power level of an add-channel input signal is adjusted to be equal to an average of the power levels of the channels included in the WDM input signal.

In some implementations, a record of the determined channel wavelengths of the add-channel input signals and the WDM input signal are maintained.

In some implementations, the channel wavelength of a new add-channel input signal is compared to the record of channel wavelengths that were determined earlier.

In some implementations, determining the channel wavelengths of the WDM input signal includes determining additional information, such as the power levels and the Optical Signal to Noise Ratios of at least one of the WDM input signal and the WDM output signal.

In some implementations, determining the channel wavelengths of the add-channel input signals includes determining additional information, such as the power levels and the Optical Signal to Noise Ratio.

In some implementations, an alarm notification is generated if an add-channel input signal is blocked. The alarm notification may include information relevant to why the add-channel input signal was blocked. For example, the alarm notification may include information such as the power level and channel wavelength of the add-channel input signal that was blocked, and of the other add-channel input signals, the WDM input signal and the WDM output signal. The alarm notification may also include a time/date stamp.

In some implementations, the add-channel input signals are selectively combined with the WDM input signal all at once.

In some implementations, the add-channel input signals are selectively combined with the WDM input signal individually.

In some implementations, determining the channel wavelengths of the add-channel input signals and the WDM input signal includes tapping off and measuring a portion of the respective signal.

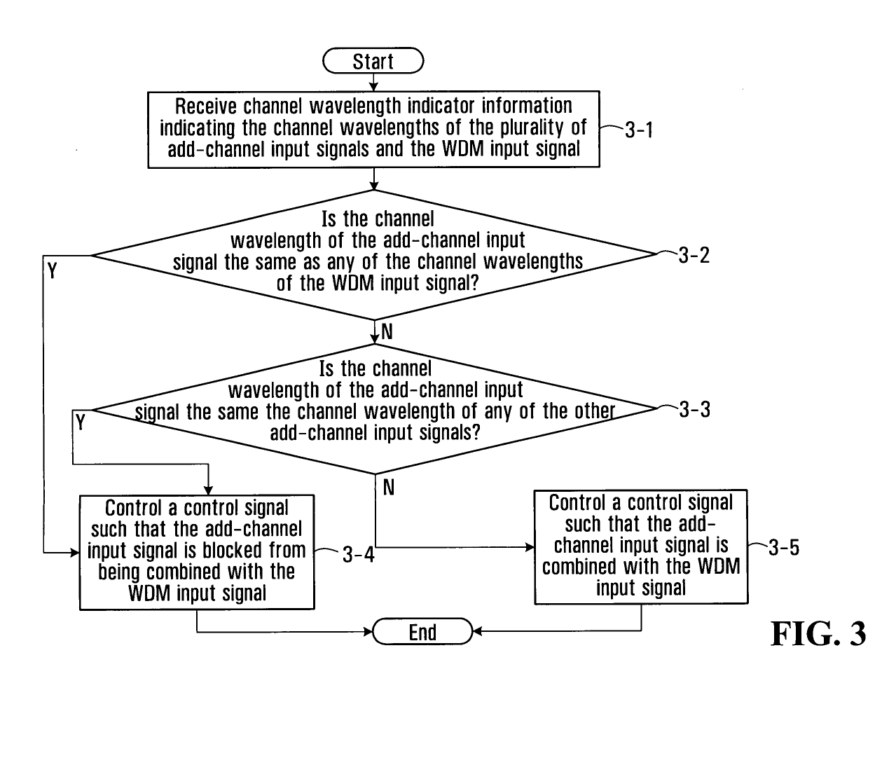

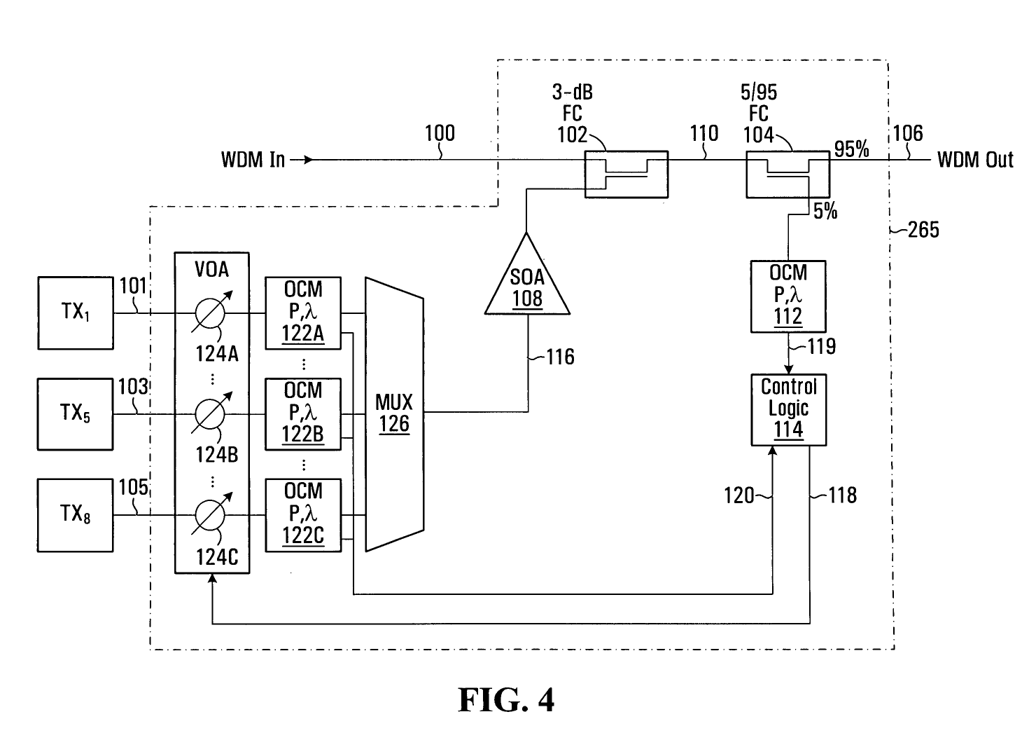

FIG. 3 is a flow chart of an example of a method for controlling a selective combiner operable to individually block or combine a plurality of add-channel input signals with a WDM input signal in order to produce a WDM output signal. The method might, for example, be implemented in the control logic 54 of the embodiments shown in FIG. 1 or in the control logic blocks 114, 142, 172, 200 and 242 of FIGS. 4 to 11, which will be described later.

The method beings at step 3-1, in which channel wavelength indicator information indicating the channel wavelengths of a plurality of add-channel input signals and the WDM input signal is received. In step 3-2, if it is determined that the channel wavelength of the add-channel input signal is the same as any of the channel wavelengths of the WDM input signal, then the method proceeds to step 3-4 (yes path), otherwise, the method proceeds to step 3-3 (no path). In step 3-3, if it is determined that the channel wavelength of the add-channel input signal is the same as the channel wavelength of any of the other add-channel input signals, the method proceeds to step 3-4 (yes path), otherwise the method proceeds to step 3-5 (no path). In step 3-4 the selective combiner is controlled such that the add-channel input signal is blocked from being combined with the WDM input signal. In step 3-5, the selective combiner is controlled such that the add-channel input signal is combined with the WDM input signal.

The net effect of the method is that the selective combiner is controlled such that an add-channel optical signal is only combined with the WDM input signal if the channel wavelength of the add-channel input signal is different than the channel wavelengths of the other add-channel input signals and the WDM input signal.

The flow chart shown in FIG. 3 is merely exemplary. Additional steps may be included, for example, in some implementations, the measurement information also includes power levels of the plurality of add-channel input signals and the at least one of the WDM input signal and the WDM output signal and the at least one control signal is controlled to not only block or combine the add-channel input signals, but also to adjust the power levels of add-channel inputs that are combined with the WDM input signal.

FIG. 4 is a block diagram of an example of a selective WDM add-channel system 265 in accordance with an embodiment of the invention in which add-channel input signals are interrogated and blocked, if necessary, to prevent signal collision. The selective WDM add-channel system 265 has a WDM input 100 to receive a WDM input signal, eight add-channel inputs to receive eight add-channel input signals and a WDM output 106 to transmit a WDM output signal. At the instant depicted, three optical signal transmitters TX₁, TX₅ and TX₈ are shown as being connected to three of the add-channel inputs 101, 103 and 105 respectively. The WDM input 100 is connected to a first input of the optical signal coupler 102, which is shown as a 3-dB FC (fiber coupler) in FIG. 4. The optical signal coupler 102 has a second input connected to the output of an optical amplifier 108, and an output 110 connected to an input of an optical tap 104, which is shown as a 5/95 FC in FIG. 4. The optical tap 104 has a first output that is connected to the WDM output 106 of the selective WDM add-channel system 265 and a second output that is connected to an input of the OCM 112. The OCM 112 has a measurement output that produces a measurement signal 119 that is connected to a first input of a control logic block 114. The control logic block 114 has a plurality of control signals 118 which are connected to control inputs of a bank of VOAs (variable optical attenuators) 124A, 124B and 124C. The VOAs 124A, 124B and 124C have signal inputs connected to the add-channel inputs 101, 103 and 105 respectively and signal outputs connected to respective inputs of OCMs 122A, 122B and 122C. The OCMs 122A, 122B and 122C each have a measurement output, which together form measurement signals 120 which are a second input of the control logic block 114. The OCMs 122A, 122B and 122C each also have a signal output that is connected to an input of a multiplexer 126. The multiplexer 126 has a multiplexed output 116 that is connected to an input of the optical amplifier 108.

In some implementations, the optical amplifier 108 is not included and the output of the multiplexer 126 is connected to the second input of the optical signal coupler 102.

Only three VOAs 124A, 124B and 124C and three OCMs 122A, 122B and 122C, corresponding to the three add-channel inputs 101, 103 and 105, which are connected to the optical signal transmitters TX₁, TX₅ and TX₈ respectively, are shown. In general, one VOA and one OCM are provided for each add-channel input.

The multiplexer 126 may be any type of multiplexer that is capable of multiplexing the optical signals that are output from the OCMs 122A, 122B and 122C. For example, the multiplexer may be a cascade of fiber couplers, a thin film filter, arrayed waveguide (AWG), fiber Bragg grating (FBG), to name a few examples

In operation, a WDM optical input that includes one or more optical channels at different channel wavelengths is applied to the WDM input 100 of the selective WDM add-channel system 265. An optical signal that is to be added to the optical channels that are already part of the WDM optical input is applied to one of the add-channel inputs, for example, an optical signal may be applied to the add-channel input 105 by connecting the optical signal transmitter TX₈. The optical signal from the optical signal transmitter TX₈ would then be applied to the signal input of the VOA 124C, where it may be passed substantially unattenuated (closed) or attenuated such that it is blocked (open). In some embodiments the VOAs are also operable to attenuate at an attenuation level somewhere between these two extremes (open and closed) in order to adjust the power level of an add-channel input signal to a desired level. The adjustment of the variable attenuation is controlled by the control signals 118 from the control logic block 114, as will be explained later. The output of the VOA 124C is then measured by the OCM 122C, which passes the output of the VOA 124C on to one of the inputs of the multiplexer 126 and also sends a measurement signal, which indicates the signal power (P) and channel wavelength (λ) of the output of the VOA 124C, to the second input of the control logic block 114 as part of the measurement signals 120. Optical signals applied to the other add-channel inputs 101 and 103 by the optical signal transmitters TX₁ and TX₅ pass through their own set of VOAs 124A and 124B and OCMs 122A and 122B respectively and are also applied to respective inputs of the multiplexer 126. Optical signals that are applied to the add-channel inputs can be added to the WDM input signal all at once or they can be added independently of one another. The multiplexer 126 multiplexes the outputs of the OCMs 122A, 122B and 122C and outputs them to the optical amplifier 108, which may be used to compensate for any losses caused by the VOAs 124A, 124B and 124C, the OCMs 122A, 122B and 122C, the multiplexer 126 or the optical signal coupler 102, thereby making the add-channel system lossless. The output of the optical amplifier 108 is applied to the second input of the optical signal coupler 102, which adds the multiplexed output of the optical amplifier 108 to the optical channels present in the optical signal applied to the WDM input 100. The output of the optical signal coupler 102, which includes the multiplexed add-channels and the optical signal applied to the WDM input 100 is applied to the input of the optical tap 104.

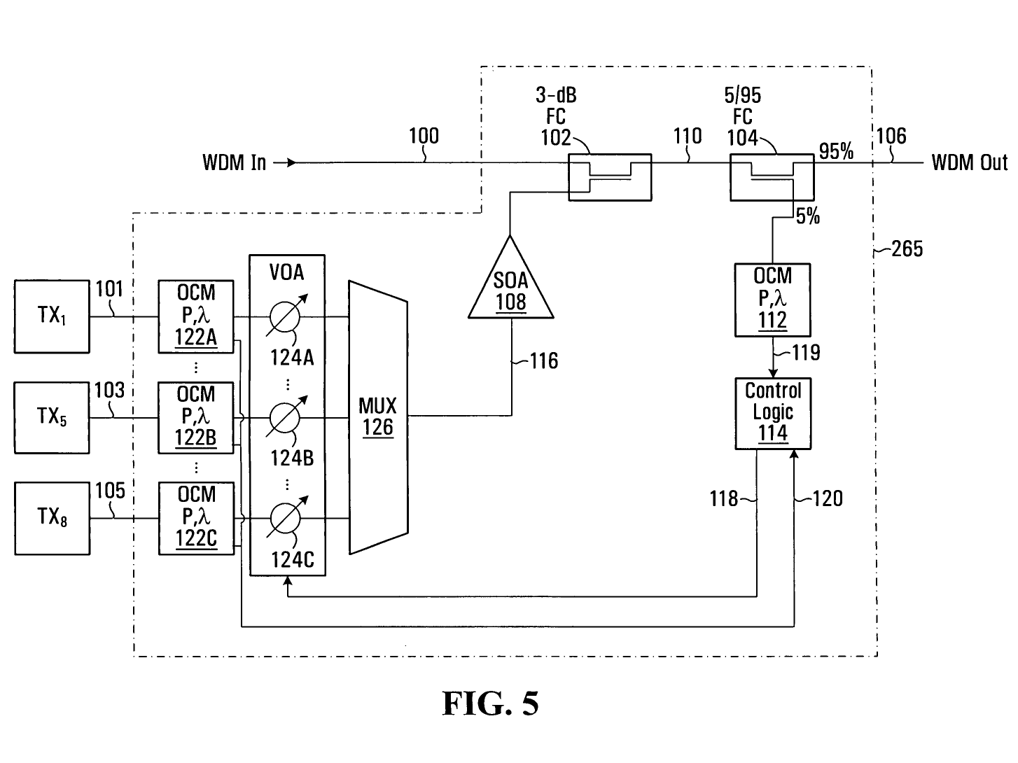

The optical tap 104 splits the signal power of its input signal such that a first portion of the input signal power is passed to the first output of the optical tap 104 and a second portion of the input signal power is passed to the second output of the optical tap 104. The first output of the optical tap 104 is connected to the WDM output 106 of the selective WDM add-channel system 265, while the second output of the optical tap 104 is used for monitoring. The tap ratio of optical tap 104, which is the ratio between the first output signal and the second output signal of the optical tap 104, is an implementation specific detail. In general, the majority of the signal power of the input signal of the optical tap 104 is passed to the first output of the optical tap 104, while only a minority of the signal power of the input signal of the optical tap 104 is passed to the second output of the optical tap 104. For example, in the implementation shown in FIG. 5 the optical tap 104 is shown as a 5/95 FC, which means that 95% of the input signal power of the optical tap 104 is passed to the first output of the optical tap 104 and hence to the WDM output 106, while only 5% of the input signal power of the optical tap 104 is passed to the second output of the optical tap 104, and hence to the input of the OCM 112 for monitoring purposes.

The OCM 112 monitors the power level and channel wavelength of the second output of the optical tap 104 and passes measurement information to the control logic block 114. The control logic block 114 uses the measurement information from the OCMs 122A, 122B and 122C that monitor the add-channel inputs and the OCM 112 that monitors the WDM output 106 to control the attenuation of the VOAs 124A, 124B and 124C.

In some implementations, the attenuation of the VOAs 124A, 124B and 124C are set by default to their maximum attenuation (open), i.e. any signals applied to the add-channel inputs are effectively blocked. When a new optical signal at a first channel wavelength is applied to one of the add-channel inputs, for example, when the optical signal transmitter TX₈ is connected to the add-channel input 105, the control logic block 114 may adjust the attenuation of the VOA 124C such that only a very attenuated optical signal is passed to the OCM 122C and hence only a very attenuated optical signal is multiplexed by the multiplexer 126 and added to the optical signal applied to the WDM input 100. The OCM 122C monitors channel wavelength and power level of the attenuated optical signal and reports this measurement information to the control logic block 114. The control logic block also monitors the measurement information generated by the OCM 112 to determine the power level and channel wavelength of the channels present in the WDM output 106, which now contains the channels present in the optical signal applied to the WDM input 100 and the multiplexed add-channels, which in this case includes the attenuated optical signal at the first wavelength generated by the optical signal transmitter TX₈. The control logic block 114 compares the channel wavelengths and power levels of the channels present in the WDM output 106 to the power and channel wavelength of the attenuated optical signal that was reported by the OCM 122C. Because only a very attenuated optical signal, i.e. low power, was added at the first channel wavelength, if the OCM 112 reports that a strong signal having the first channel wavelength is included in the WDM output 106, the control logic block 114 concludes that an optical signal having the first channel wavelength is already present in the WDM input 100 or has already been added at one of the other add-channel inputs 101, 103 and would set the attenuation of the VOA 124C to its maximum attenuation (open) in order to block the optical signal applied to the add-channel input 105. For example, if the optical signal applied to the add-channel input 105 is attenuated to −20 dBm of signal power in the first channel wavelength, and the OCM 112 reports that an optical signal at 10 dBm of signal power in the first channel wavelength is present in the WDM output 106, then the control logic block 114 concludes that the additional power in the first channel wavelength is caused by another optical signal in the first channel wavelength and would block the optical signal applied to the add-channel input 105 with the VOA 124C. Alternatively, if the measurement information reported by the OCM 112 indicates that the power level of the optical signal in the WDM output 106 in the first channel wavelength is consistent with the attenuated power level of the attenuated add-channel input signal reported by the OCM 122C, the control logic block 114 concludes that neither the WDM input 100 nor any previously added add-channel input signal includes an optical signal at the first channel wavelength and would therefore adjust the attenuation of the VOA 124C so as to allow the optical signal generated by the optical signal transmitter TX₈ to be added to the channels present in the WDM input 100.

The threshold for deciding if a power level of a given channel wavelength in the WDM output 106 is consistent with the power level of the given channel wavelength in an add-channel input signal is an implementation specific detail.

When the control logic block 114 decides that an add-channel input signal is to be added to the WDM input 100, it may set the respective VOA to its minimum attenuation (closed) or it may set the respective VOA to a specific level of attenuation in order to attenuate the add-channel input signal to a desired power level. The control logic block 114 may set the attenuation of a respective VOA so that the power level of the add-channel input signal matches the power level of the other signals present in the WDM output 106.

In the example embodiment shown in FIG. 4, the VOAs 124A, 124B and 124C are located between the add-channel inputs 101, 103 and 105 and the OCMs 122A, 122B and 122C, which means that any optical signals which are passed to the OCMs 122A, 122B and 122C for monitoring are also multiplexed by the multiplexer 126 and added to the WDM input signal. For this reason, as discussed above, optical signals applied to the add-channel inputs 101, 103 and 105 are first set to a very attenuated level and added to the WDM input signal so that the very attenuated signals can be monitored without interfering with existing channels with the same channel wavelength.

FIG. 5 shows an example embodiment whereby the add-channel input signals can be monitored prior to being added to the WDM input signal. The only difference between the example embodiment shown in FIG. 4 and the example embodiment shown in FIG. 5 is that in the example embodiment shown in FIG. 5, rather than being connected between the add-channel inputs 101, 103 and 105 and the OCMs 122A, 122B and 122C, the VOAs 124A, 124B and 124C are connected between the OCMs 122A, 122B and 122C and the multiplexer 126 and the inputs of the OCMs 122A, 122B and 122C are connected to the add-channel inputs 101, 103 and 105 respectively.

In some implementations, VOAs are included both before and after the OCMs 122A, 122B and 122C in order to protect the input of the OCMs 122A, 122B and 122C from strong add-channel input signals that may damage the OCMs 122A, 122B and 122C and to allow the output of the OCMs 122A, 122B and 122C to be attenuated so that the add-channel input signals can be monitored without being multiplexed and added to the WDM input 100.

In operation, the control logic block 114 of the selective WDM add-channel system 265 shown in FIG. 5 operates very similarly to the control logic block 114 of the selective WDM add-channel system 265 shown in FIG. 4. However, in the example embodiment shown in FIG. 5, the control logic block 114 can monitor the add-channel input signals with the OCMs 122A, 122B and 122C and compare the channel wavelengths and power levels of the add-channel input signals and the channel wavelengths and power levels of the WDM output 106 without causing the add-channel input signals, or even attenuated add-channel input signals, to be added to the WDM input signal and hence the WDM output signal.

In the embodiments shown in FIGS. 4 and 5, only the measurement signals 119 and 120 and the control signals 118 are electrical signals. All of the other signals shown in FIGS. 4 and 5 are optical signals.

In the embodiments shown in FIGS. 4 and 5, the plurality of VOAs, of which only three are shown 124A, 124B and 124C, the multiplexer 126 and the 3-dB FC 102 form the selective combiner 52 of the selective add-channel system 50 shown in FIG. 1. In FIGS. 4 and 5, the plurality of OCMs, of which only three are shown 122A, 122B and 122C, the optical tap 104 and the OCM 112 represent the channel wavelength determiner 53 of FIG. 1.

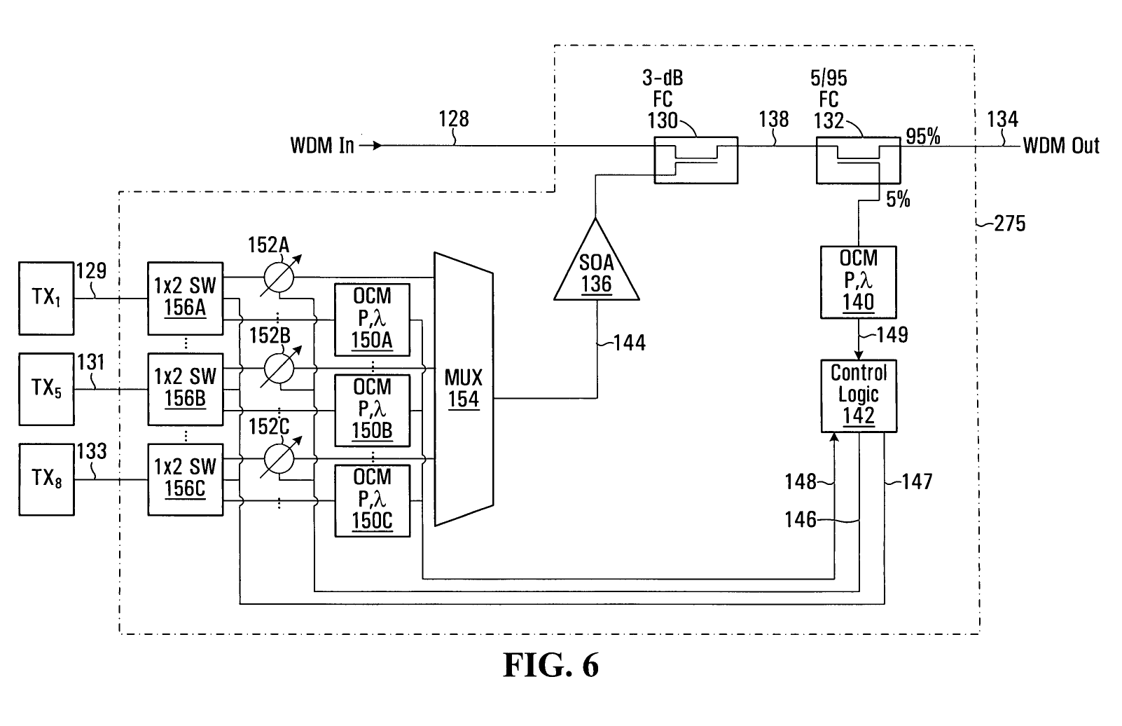

FIG. 6 is a block diagram of a second example embodiment of a selective WDM add-channel system 275 in which add-channel input signals are interrogated before they are added, even in part, to a WDM input signal in order to prevent signal collision. The selective WDM add-channel system 275 has a WDM input 128 to receive the WDM input signal, eight add-channel inputs to receive eight add-channel input signals, although only three are shown 129, 131 and 133, and a WDM output 134 to transmit a WDM output signal. At the instant depicted, three optical signal transmitters TX₁, TX₅ and TX₈ are shown as being connected to the three add-channel inputs 129, 131 and 133 respectively. The WDM input 128 is connected to a first input of an optical signal coupler 130, which is shown as a 3-dB FC in FIG. 6. The optical signal coupler 130 has a second input connected to the output of an optical amplifier 136, and an output 138 connected to an input of an optical tap 132, which is shown as a 5/95 FC in FIG. 6. The tap ratio of the optical tap 132 is an implementation specific detail, as described above with reference to FIG. 4. The optical tap 132 has a first output that is connected to the WDM output 134 of the selective WDM add-channel system 275 and a second output that is connected to an input of an OCM 140. The OCM 140 has a measurement output to produce a measurement signal 149 that is connected to a first input of a control logic block 142. The control logic block 142 has a first plurality of control signals 146 which are respectively connected to the control inputs of a bank of VOAs 152A, 152B and 152C and a second plurality of control signals 147 which are respectively connected to the control inputs of a bank of 1×2 switches 156A, 156B and 156C. The 1×2 switches 156A, 156B and 156C have signal inputs that are connected to the add-channel inputs 129, 131 and 133 respectively. The 1×2 switches 156A, 156B and 156C have first signal outputs that are connected to signal inputs of the VOAs 152A, 152B and 152C respectively, and second signal outputs that are connected to signal inputs of a bank of OCMs 150A, 150B and 150C respectively. The VOAs 152A, 152B and 152C have signal outputs connected to respective inputs of a multiplexer 154. The OCMs 150A, 150B and 150C each have a measurement output, which together form measurement signals 148 which are a second input of the control logic block 114. The multiplexer 154 has a multiplexed output 144 that is connected to an input of the optical amplifier 136.

In some implementations, the optical amplifier 136 is not included and the output of the multiplexer 154 is connected to the second input of the optical signal coupler 130.

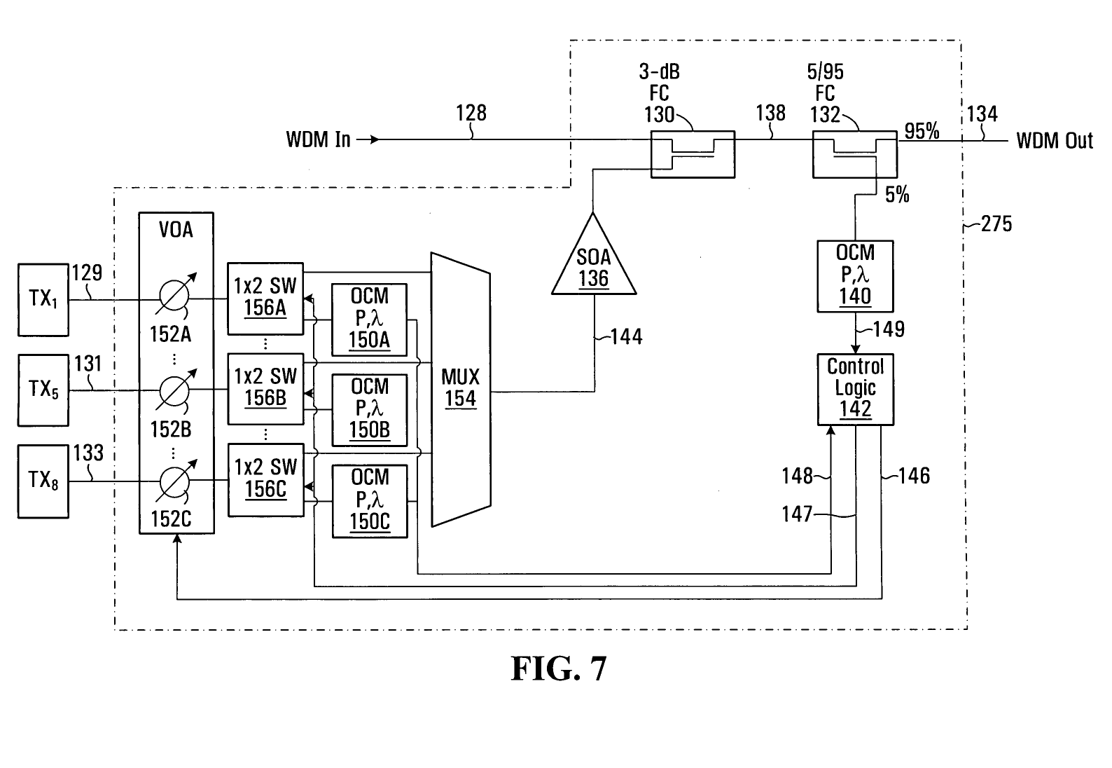

Only three add channel inputs 129, 131 and 133 and their associated respective components are shown in FIG. 7, i.e. the three 1×2 switches 156A, 156B and 156C; the VOAs 152A, 152B and 152C; and the three OCMs 150A, 150B and 150C. In general, a selective WDM add-channel system according to the present invention may have any number of add-channel inputs and one 1×2 switch, one VOA, and one OCM is provided for each add-channel input.

The multiplexer 154 may be any type of multiplexer that is capable of multiplexing the optical signals that are output from the VOAs 152A, 152B and 152C. For example, the multiplexer may be a cascade of fiber couplers, a thin film filter, arrayed waveguide (AWG), fiber Bragg grating (FBG), to name a few examples

In operation, a WDM input signal that includes one or more optical channels at different channel wavelengths is applied to the WDM input 128 of the selective WDM add-channel system 275. When an optical signal transmitter is connected to one of the add-channel inputs 129, 131 and 133, for example, when the optical signal transmitter TX₈ is connected to the add-channel input 133 as shown in FIG. 6, the control logic block 142 will switch the 1×2 switch 156C such that the optical signal applied to the add-channel input 133 is switched to the signal input of the OCM 150C.

The OCM 150C measures the power level and channel wavelength of its signal input and reports this measurement information to the control logic block 142.

The control logic block 142 also monitors the power levels and channel wavelengths of the channels present in the WDM output signal via measurement information provided by the OCM 140. The control logic block 142 then compares the measurement information of the optical signal applied to the add-channel input 133 to the measurement information of the WDM output signal to determine if the WDM output signal includes a channel with the same channel wavelength as the optical signal applied to the add-channel input 133 by TX₈. If this is the case, it could be that an already added optical signal from one of the other add-channel inputs 129, 131 has the same channel wavelength as the optical signal applied to the third add-channel input 133 by TX₈, alternatively the WDM input signal may include a channel at the same channel wavelength.

If the control logic block 142 determines that channel with substantially the same channel wavelength is already present in the WDM output signal, then the control logic block 142 will maintain the 1×2 switch such that the optical signal applied to the add-channel input 133 is switched to the OCM 150C. Alternatively, the control logic block 142 may set the VOA 152C to its maximum attenuation (open) and switch the 1×2 switch 156C such that the optical signal applied to the add-channel input 133 is switched to the signal input of the VOA 152C where it will be effectively blocked by the VOA 152C. In either of these scenarios, the optical signal applied to the add-channel input 133 will not be allowed to reach the multiplexer 154 and therefore will not be combined with the WDM input signal to form the WDM output signal.

Alternatively, if the control logic block 142 determines that the WDM output 134 does not contain a channel with the same channel wavelength as the optical signal applied to the add-channel input 133, the control logic block 142 will set the VOA 152C to a desired attenuation level, typically the lowest attenuation level (closed), and will switch the 1×2 switch 156C such that the optical signal applied to the add-channel input 133 is switched to the signal input of the VOA 152C. The VOA 152C attenuates the optical signal to the desired level and passes it to the multiplexer 154 where it is combined with other add-channel input signals that have not been blocked to form a WDM add signal. The WDM add signal is amplified by the optical amplifier 136, combined with the WDM input signal by the optical signal coupler 130 and passed to WDM output 134 through the optical tap 132, which also taps a small amount of the signal power to the OCM 140 for monitoring as discussed above.

The operation of the selective WDM add-channel system 275 described above effectively protects against the addition of duplicate channel wavelengths and the resulting signal collisions.

While the above has described the operation of the selective WDM add-channel system 275 for the interrogation and blocking or addition of an optical signal at the add-channel input 133 using the 1×2 switch 156C, the VOA 152C and the OCM 150C, similar operations may be executed for optical signals applied to the other add-channel inputs using their associated 1×2 switches 156A and 156B, VOAs 152A and 152B and OCMs 150A and 150B.

In the example implementation shown in FIG. 6, the VOAs 152A, 152B and 152C are connected between the first output of the 1×2 switches 156A, 156B and 156C respectively and the inputs of the multiplexer 154. The signal inputs of the 1×2 switches 156A, 156B and 156C are also connected directly to the add-channel inputs 129, 131 and 133 respectively. This means that the optical signals applied to the add-channel inputs are applied directly to the signal inputs of the 1×2 switches 156A, 156B and 156C and are only attenuated once the 1×2 switches 156A, 156B and 156C have been switched such that the add-channel optical signals are applied to the VOAs 152A, 152B and 152C respectively, rather than to the OCMs 150A, 150B and 150C. This also means that the full strength of the optical signals applied to the add-channel inputs 129, 131 and 133 are applied to the signal inputs of the OCMs 150A, 150B and 150C. In some cases, optical components such as switches and OCMs can be damaged if large signals are applied to them without first being attenuated.

FIG. 7 shows an example embodiment that is very similar to the example embodiment shown in FIG. 6. The only difference between the example embodiment shown in FIG. 6 and the example embodiment shown in FIG. 7 is that in the example embodiment shown in FIG. 7, rather than being connected between the first outputs of the 1×2 switches 156A, 156B and 156C and the inputs of the multiplexer 154, the VOAs 152A, 152B and 152C are connected between the add-channel inputs 129, 131 and 133 and the inputs of the 1×2 switches 156A, 156B and 156C respectively. As a result, the first outputs of the 1×2 switches are connected to the inputs of the multiplexer 154 in the example embodiment shown in FIG. 7.

In operation, the selective WDM add-channel system 275 shown in FIG. 7 is very similar to the selective WDM add-channel system 275 shown in FIG. 6; however, with the VOAs 152A, 152B and 152C connected before the 1×2 switches 156A, 156B and 156C, the add-channel optical signals applied to the add-channel inputs 129, 131 and 133 can be attenuated to the desired level while the 1×2 switches are switching the optical signals to the OCMs 150A, 150B and 150C for measurement and the VOAs 152A, 152B and 152C may also protect the signal inputs of the 1×2 switches 156A, 156B and 156C and the OCMs 150A, 150B and 150C. In this way the control logic block can block an optical signal applied to one of the add-channel inputs, for example add-channel input 133, by setting the VOA 152C to its maximum attenuation (open) and by having the 1×2 switch 156C set to switch the completely attenuated optical signal to the OCM 150C. Of course, the optical signal could also be blocked by setting the VOA 152C to its maximum attenuation (open) and by setting the 1×2 switch 156C set to switch the completely attenuated optical signal to the input of the multiplexer 154, because adding the completely attenuated optical signal to the WDM input 128 should not cause a signal collision.

In the embodiments shown in FIGS. 6 and 7, only the measurement signals 148 and 149 and the control signals 146 and 147 are electrical signals. All of the other signals shown in FIGS. 6 and 7 are optical signals.

In the embodiments shown in FIGS. 6 and 7, the plurality of VOAs, of which only three are shown 152A, 152B and 152C, the multiplexer 154 and the 3-dB FC 130 form the selective combiner 52 of the selective add-channel system 50 shown in FIG. 1. In FIGS. 6 and 7, the plurality of 1×2 switches, of which only three are shown 156A, 156B and 156C, the plurality of OCMs, of which only three are shown 150A, 150B and 150C, the optical tap 132 and the OCM 140 represent the channel wavelength determiner 53 of FIG. 1.

In the example embodiments shown in FIGS. 4 to 7, an optical tap has been provided immediately before the WDM output of the selective WDM add-channel systems shown in these Figures. In this location the optical tap tapped off a portion of the WDM output signal for measurement by an OCM connected to the control logic block. In some implementations, an optical tap may instead be placed at the WDM input of the selective WDM add-channel system, so as to tap off a portion of the WDM input for measurement by an OCM connected to the control logic block. In general, the WDM input signal may be used in place of, or in addition to, the WDM output signal in the selective WDM add-channel systems described above to determine the channels present in the WDM input signal in order to prevent a signal collision.

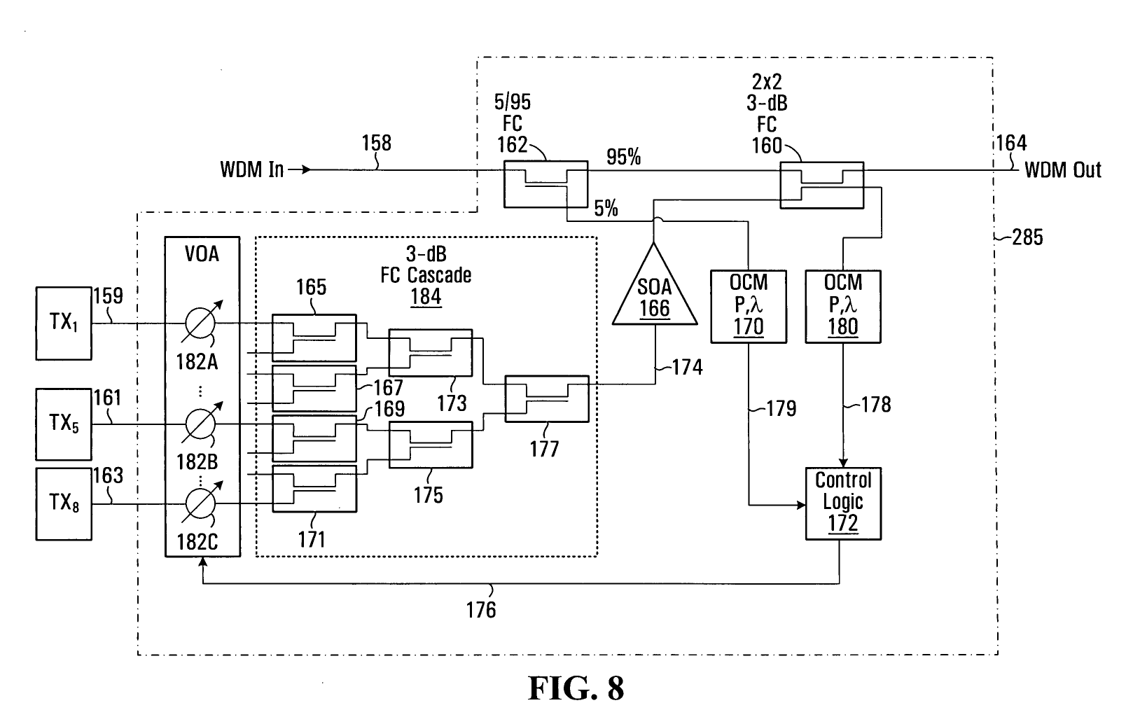

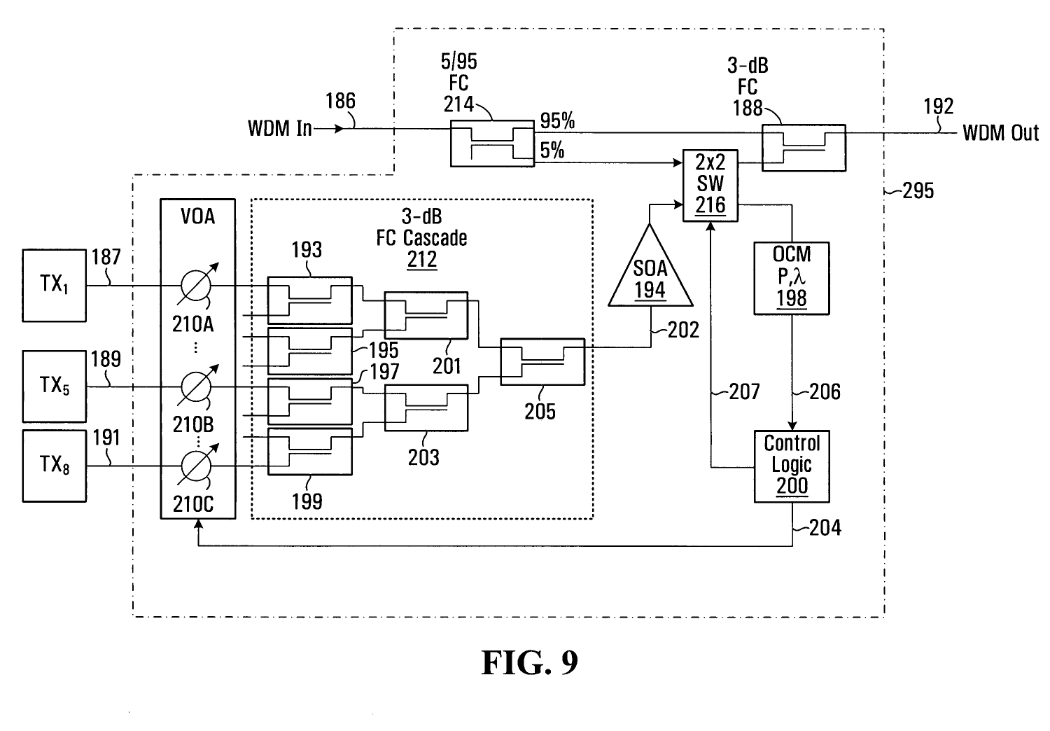

FIG. 8 is a block diagram of an example embodiment of a selective WDM add-channel system 285 in which add-channel input signals are interrogated in order to prevent signal collision. The selective WDM add-channel system 285 has a WDM input 158 to receive a WDM input signal, eight add-channel inputs to receive eight add-channel input signals, although only three add-channel inputs are shown 159, 161 and 163, and a WDM output 164 to transmit a WDM output signal. At the instant depicted, three optical signal transmitters TX₁, TX₅ and TX₈ are shown as being connected to the three add-channel inputs 159, 161 and 163 respectively. The WDM input 158 is connected to a first input of an optical tap 162, which is shown as a 5/95 FC in FIG. 8. The optical tap 162 has a first signal output connected to a first signal input of a 2×2 optical signal coupler 160, which is shown as a 2×2 3-dB FC in FIG. 8. The optical tap 162 has a second signal output that is connected to the signal input of an OCM 170. The tap ratio of the optical tap 162 is an implementation specific detail, as described above with reference to FIG. 4. The 2×2 optical signal coupler 160 has a second signal input connected to an output of an optical amplifier 166. The 2×2 optical signal coupler 160 has a first signal output connected to the WDM output 164 and a second signal output connected to a signal input of an OCM 180. The OCMs 170 and 180 have measurement outputs 179 and 178 respectively, which are connected to inputs of a control logic block 172. The control logic block 172 has a plurality of control signals 176, which are respectively connected to the control inputs of a bank of VOAs 182A, 182B and 182C. The VOAs 182A, 182B and 182C have signal inputs that are connected to the add-channel inputs 159, 161 and 163 respectively. The VOAs 182A, 182B and 182C have signal outputs that are connected to the inputs of a multiplexer 184, which is shown as a 3-dB FC cascade combiner in FIG. 9. The multiplexer 184 has a multiplexed output 174 that is connected to an input of the optical amplifier 166. The eight input 3-dB FC cascade combiner 184 shown in FIG. 9 is made of seven two input, one output 3-dB FCs 165, 167, 169, 171, 173, 175 and 177. The 3-dB FCs are arranged and connected such that the two-inputs of the 3-dB FCs 165, 167, 169 and 171 are connected to the inputs of the multiplexer 184 and the outputs of the 3-dB FCs 165 and 167 are connected to the two inputs of the 3-dB FC 173, while the outputs of the 3-dB FCs 169 and 171 are connected to the two inputs of the 3-dB FC 175. The outputs of the 3-dB FCs 173 and 175 are connected to the two inputs of the 3-dB FC 177 and the output of the 3-dB FC 177 is connected to the output 174 of the multiplexer 184.

In some implementations, the optical amplifier 166 is not included and the output of the multiplexer 184 is connected to the second input of the optical signal coupler 160.

Only the three add channel inputs 159, 161 and 163 and the three VOAs 182A, 182B and 182C are shown in FIG. 8. In general, a selective WDM add-channel system according to the present invention may have any number of add-channel inputs and one VOA is provided for each add-channel input. While the 3-dB FC cascade combiner 184 is capable of multiplexing up to eight add-channel inputs, additional add-channel inputs can be multiplexed by adding additional stages to the cascade, however this will cause a greater loss through the multiplexer, as each new stage will add 3-dB of loss. Therefore, the number of cascaded 3-dB FC stages will be limited by the loss that is acceptable from the multiplexer. One advantage of the 3-dB FC cascade combiner is that it is very cheap to implement and is colorless in the sense that any channel wavelength can be applied to any add-channel input, whereas some multiplexers require that only specific channel wavelengths be applied to specific inputs.

While the 2×2 optical signal coupler 160 is shown as a 2×2 3-dB FC in FIG. 8, more generally any 2×2 optical signal coupler that is capable of coupling a first input signal and a second input signal to generate a coupled output signal at a first signal output and at a second signal output may be used, provided that the performance of the optical signal coupler satisfies implementation specific design requirements such as signal loss and bandwidth.

Although the multiplexer 184 is shown as a 3-dB FC cascade combiner, the multiplexer 184 may be any type of multiplexer that is capable of multiplexing the optical signals that are output from the VOAs 182A, 182B and 182C.

In operation, a WDM input signal that includes one or more optical channels at different channel wavelengths is applied to the WDM input 158 of the selective WDM add-channel system 285, which is connected to the signal input of the optical tap 162. The optical tap 162, splits the WDM input signal between its first output, which is connected to the first signal input of the 2×2 optical signal coupler 160, and its second signal output, which is connected to the signal input of the OCM 170. An add-channel optical signal that is to be added to the optical channels that are already part of the WDM signal input is applied to one of the add-channel inputs, for example, an add-channel optical signal may be applied to the add-channel input 163 by connecting the optical signal transmitter TX₈. The optical signal from the optical signal transmitter TX₈ would then be applied to the signal input of the VOA 182C, where it may be passed substantially unattenuated (closed) or attenuated such that it is substantially blocked (open).

In some embodiments, the VOA is also operable to attenuate at attenuation levels between these two extremes in order to adjust the power level of an add-channel input signal.

The adjustment of the variable attenuation is controlled by the control signals 176 from the control logic block 172, as will be explained later. The signal output of the VOA 182C is then passed to one of the inputs of the 3-dB FC cascade combiner 184. Optical signals applied to the other add-channel inputs 159 and 161 by the optical signal transmitters TX₁ and TX₅ pass through their own set of VOAs 182A and 182B respectively and are also applied to respective inputs of the multiplexer 184. Optical signals that are applied to the add-channel inputs can be added to the WDM input signal all at once or they can be added independently of one another.

The multiplexer 184 multiplexes the outputs of the VOAs 182A, 182B and 182C to produce a WDM add signal. The WDM add signal is amplified by the optical amplifier 166, which may be used to compensate for any losses caused by the VOAs 182A, 182B and 182C, the multiplexer 184 or the 2×2 optical signal coupler 160, thereby making the add-channel system lossless. The output of the optical amplifier 166 is applied to the second input of the 2×2 optical signal coupler 160, which combines the amplified WDM add signal with the portion of the WDM input signal tapped off to the first signal output of the optical tap 162. The first signal output and the second signal output of the 2×2 optical signal coupler 160, which include the channel wavelengths of the WDM add signal and the WDM input signal, are applied to the WDM output 164 as a WDM output signal and the signal input of the OCM 180 respectively.

The OCM 180 monitors the power level and channel wavelengths of the WDM output signal, which includes the amplified WDM add signal, by measuring the second signal output of the 2×2 optical signal coupler 160 and passes measurement information to the control logic block 172 via the measurement signals 178. The OCM 170 monitors the power level and wavelength of the WDM input signal by measuring the second output of the optical tap 162 and passes measurement information to the control logic block 172 via the measurement signals 179. The control logic block 172 uses the measurement information from the OCMs 170 and 180 to control the attenuation of the VOAs 182A, 182B and 182C.

In some implementations, the attenuation of the VOAs 182A, 182B and 182C are set by default to their maximum attenuation (open), i.e. any signals applied to the add-channel inputs are effectively blocked. When a new optical signal with a first channel wavelength is applied to one of the add-channel inputs, for example, when the optical signal transmitter TX₈ is connected to the add-channel input 163, the control logic block 172 may adjust the attenuation of the VOA 182C such that only a very attenuated optical signal is passed to the multiplexer 184 and hence only a very attenuated optical signal is added to the optical signal applied to the WDM input 158.

The control logic block 172 monitors the measurement information generated by the OCM 180 to determine the power level and channel wavelength of the channels present in the WDM output signal, which now contains the channels present in the WDM input signal and the multiplexed WDM add signal, which in this case includes the attenuated optical signal with the first wavelength. The control logic block 172 also monitors the measurement information generated by the OCM 170 to determine the power levels and channel wavelengths of the WDM input signal. The control logic block 172 compares the channel wavelengths and power levels of the channels present in the WDM output signal reported by the OCM 180 to the power levels and channel wavelengths of the WDM input signal reported by the OCM 170.

If the OCM 180 reports that the WDM output includes only channel wavelengths and power levels that are consistent with the channel wavelengths and power levels of the WDM input signal reported by the OCM 170, the control logic block 172 concludes that an optical signal with the first channel wavelength is already present in the WDM input signal and sets the attenuation of the VOA 182C to its maximum attenuation (open) in order to block the optical signal applied to the add-channel input 163. Alternatively, if the measurement information reported by the OCM 180 indicates that the WDM output signal includes a channel with the first channel wavelength and the OCM 170 reports that the WDM input signal does not include a channel with the first channel wavelength, the control logic block 172 concludes that the WDM input signal does not include an optical signal at the first channel wavelength.

After interrogating all of the add-channel input signals, the control logic block 172 adjusts the attenuation of the VOAs so as to allow add-channel input signals with channel wavelengths that are different from each other and are different than the channel wavelengths of the channels of the WDM input signal, to be added to the WDM input signal.

When the control logic block 172 decides that an add-channel input signal is to be added to the WDM input signal it may set the respective VOA to its minimum attenuation (closed). In some embodiments it may set the respective VOA to a specific level of attenuation in order to attenuate the add-channel input signal to a desired power level. The control logic block 172 may set the attenuation of a respective VOA so that the power level of the add-channel input signal matches the power level of the other channels present in the WDM output signal.

In the embodiments shown in FIG. 8, only the measurement signals 178 and 179 and the control signals 176 are electrical signals. All of the other signals shown in FIG. 8 are optical signals.

In the embodiment shown in FIG. 8, the plurality of VOAs, of which only three are shown 182A, 182B and 182C, the multiplexer 184 and the 2×2 3-dB FC 160 form the selective combiner 52 of the selective add-channel system 50 shown in FIG. 1. In FIG. 8, the OCM 180, the OCM 170 and the optical tap 162 represent the channel wavelength determiner 53 of FIG. 1.

FIG. 9 is a block diagram of a selective WDM add-channel system 295 that is similar to the selective WDM add-channel system 285 shown in FIG. 9, except that the selective WDM add-channel system 295 includes a 2×2 switch 216 and only one OCM 198. The selective WDM add-channel system 295 has a WDM input 186 to receive a WDM input signal, eight add-channel inputs to receive eight add-channel input signals, although only three add-channel inputs are shown 187, 189 and 191, and a WDM output 192 to transmit a WDM output signal.

At the instant depicted, three optical signal transmitters TX₁, TX₅ and TX₈ are shown as being connected to the three add-channel inputs 187, 189 and 191 respectively. The WDM input 186 is connected to an input of an optical tap 214, which is shown as a 5/95 FC optical tap in FIG. 9. The tap ratio of the optical tap 162 is an implementation specific detail, as described above with reference to FIG. 4. The optical tap 214 has a first output connected to a first input of an optical signal coupler 188, which is shown as a 3-dB FC in FIG. 9. The optical tap 214 has a second output that is connected to a first input of the 2×2 switch 216. The optical signal coupler 188 has a second input connected to a first output of the 2×2 switch 216 and an output connected to the WDM output 192 of the selective WDM add-channel system 295. The 2×2 switch 216 has a second input connected to an output of an optical amplifier 194 and a second output connected to a signal input of the OCM 198. The 2×2 switch 216 also has a control input that is connected to a first control output 207 of a control logic block 200. The control logic block 200 has a measurement input that is connected to a measurement output of the OCM 198 to receive a measurement signal 206, and a plurality of control signals 204 that are respectively connected to a bank of VOAs 210A, 210B and 210C. The VOAs 210A, 210B and 210C have signal inputs that are connected to the add-channel inputs 187, 189 and 191 respectively. The VOAs 210A, 210B and 210C have signal outputs that are connected to the inputs of a multiplexer 212, which is shown as a 3-dB FC cascade combiner in FIG. 9. The multiplexer 184 has a multiplexed output 202 that is connected to an input of the optical amplifier 194. The eight input 3-dB FC cascade combiner 212 shown in FIG. 9 is made up of seven 3-dB FCs 193, 195, 197, 199, 201, 203 and 205, which are connected in the same manner as the seven 3-dB FCs 165, 167, 169, 171, 173, 175 and 177 which make up the multiplexer 184 shown in FIG. 8.

In some implementations, the optical amplifier 194 is not included and the output of the multiplexer 212 is connected to the second input of the 2×2 switch 216.

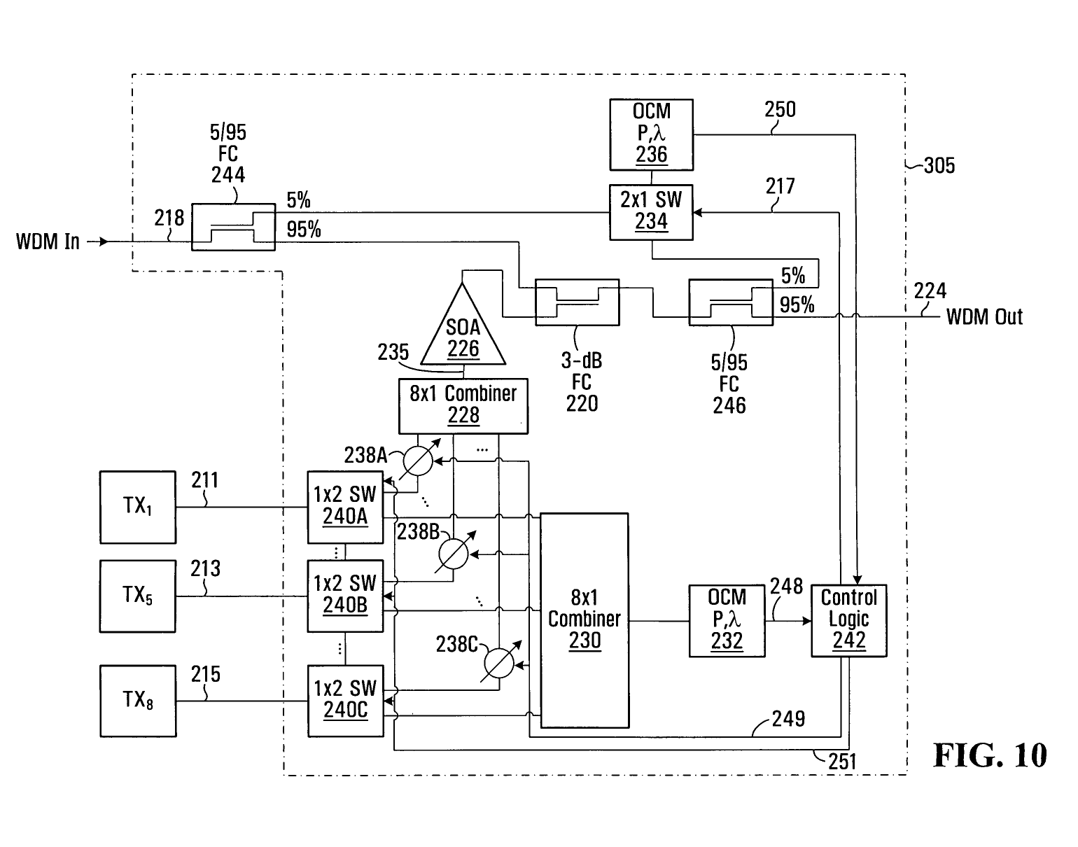

Only the three add channel inputs 187, 189 and 191 and the three VOAs 210A, 210B and 210C are shown in FIG. 10. In general, a selective WDM add-channel system according to the present invention may have any number of add-channel inputs and one VOA is provided for each add-channel input. While the 3-dB FC cascade combiner 212 is capable of multiplexing up to eight add-channel inputs, additional add-channel inputs can be multiplexed by adding additional stages to the cascade as discussed above with reference to FIG. 8.

Although the multiplexer 212 is shown as a 3-dB FC cascade combiner, the multiplexer 212 may be any type of multiplexer that is capable of multiplexing the optical signals that are output from the VOAs 210A, 210B and 210C.

In operation, a WDM input signal that includes one or more optical channels at different channel wavelengths is applied to the WDM input 186 of the selective WDM add-channel system 295. An add-channel optical signal that is to be added to the optical channels that are already part of the WDM optical input is applied to one of the add-channel inputs, for example, an optical signal may be applied to the add-channel input 191 by connecting the optical signal transmitter TX₈. The optical signal from the optical signal transmitter TX₈ would then be applied to the signal input of the VOA 210C, where it may be passed substantially unattenuated (closed) or attenuated such that it is substantially blocked (open).

In some embodiments, the VOA is operable to attenuate at attenuation levels between these two extremes (open and closed) in order to adjust the power level of an add-channel optical signal. The adjustment of the variable attenuation is controlled by the control signals 204 from the control logic block 200, as will be explained later. The signal output of the VOA 210C is then passed to one of the inputs of the 3-dB FC cascade combiner 212.

Optical signals applied to the other add-channel inputs 187 and 189 by the optical signal transmitters TX₁ and TX₅ pass through their own set of VOAs 210A and 210B respectively and are also applied to respective inputs of the multiplexer 212.

The multiplexer 212 multiplexes the outputs of the VOAs 210A, 210B and 210C to produce a WDM add signal which is amplified by the optical amplifier 194, which may be used to compensate for any losses caused by the VOAs 210A, 210B and 210C, the multiplexer 212, the 2×2 switch 216 or the optical signal coupler 188, thereby making the add-channel system lossless. The output of the optical amplifier 194 is applied to the second input of the 2×2 switch 216. The 2×2 switch 216 is controlled by the first control signal 207 from the control logic block 200. The 2×2 switch can be controlled to switch its two inputs between its two outputs such that while one input is switched to one output, the other input is switched to the other output, which means that the amplified WDM add signal output of the optical amplifier 194 can be switched to either the second input of the optical signal coupler 188 for combination with the WDM input signal or to the signal input of the OCM 198 for monitoring. Similarly, the second output of the optical tap 214 can be switched to the OCM 198 so that the WDM input optical signal can be measured.

The OCM 198 monitors the power level and channel wavelength of the optical signal output to the 2×2 switch's 216 second output. The control logic block 200 uses the measurement information from the OCM 198 to control the attenuation of the VOAs 210A, 210B and 210C and the switching of the 2×2 switch 216.

Under normal operating conditions, i.e. when possibly one or more add-channels have been added to the WDM signal input to produce the WDM output signal, the 2×2 switch will be set such that the second output of the optical tap 214 is switched to the signal input of the OCM 198 and the amplified WDM add signal output of the optical amplifier 194 is switched to the second input of the optical signal coupler 188. In this way previously approved add-channels are included in WDM output signal and the WDM input signal is monitored by the OCM 198 so that the power levels and channel wavelengths of the channels included in the WDM input signal are available to the control logic block 200.

The VOAs 210A, 210B and 210C are generally set by default to their maximum attenuation (open) so that when an optical signal transmitter is connected to one of the add-channel inputs, the optical signal generated by the transmitter is completely attenuated by the VOA and will not damage any of the other components or be added to WDM output 192.

When an optical signal transmitter is connected to one of the add-channel inputs, for example, when the optical transmitter TX₈ is connected to the add-channel input 191, the control logic block 200 will set the 2×2 switch such that the second input of the 2×2 switch is switched to the signal input of the OCM 198, rather than to the second input of the optical signal coupler 188. This allows the WDM add signal, which in this example includes the add-channel optical signal applied to the add-channel input 191 by the optical signal transmitter TX₈, to be measured by the OCM 198.

The control logic block 200 will also adjust the attenuation of the VOA 210C, such that the optical signal applied to the add-channel input 191 is passed to the multiplexer 212 and hence is included in the WDM add signal. The second output of the optical tap 214 may be switched to the second input of the optical signal coupler 188. The control logic block 200 compares the power levels and channel wavelengths of the optical signals included in the WDM add signal, which includes the add-channel optical signal applied to the add-channel input 191, to the power levels and channel wavelengths of the WDM input 186, which were reported when the 2×2 switch was set such that the second output of the optical tap 214 was switched to the signal input of the OCM 198.

If the add-channel optical signals are at different channel wavelengths than the channels included in the WDM input signal, then the control logic block 200 may switch the 2×2 switch 216 such that the output of the optical amplifier 194 is switched to the second input of the optical signal coupler 188 and adjust the VOA 210C such that the optical signal applied to the add-channel input 191 by the optical signal transmitter TX₈ is passed to the multiplexer 212 and hence added to the WDM output 192. Alternatively, if the optical signal applied to the add-channel input 191 is found to have the same channel wavelength as one of the channels of the WDM input signal or one of the other add-channel input signals, the control logic block 200 would set the VOA 210C to its maximum attenuation level (open) in order to prevent it from being added to the WDM input signal in order to prevent a signal collision.

In some implementations, when the control logic block 200 switches the 2×2 switch 216 such that the output of the optical amplifier 194 is connected to the signal input of the OCM 198 for measurement, the control logic block 200 will first set all of the VOAs 210A, 210B and 210C to their maximum attenuation, and then measure each of the add-channel optical signals individually, i.e. adjust the attenuation of the VOAs 210A, 210B and 210C one at a time so as to allow the optical signal from only one add-channel input at a time to be measured. In this way, the control logic block 200 may determine if any of the optical signals which are applied to the add-channel inputs have the same channel wavelength.

In the embodiment shown in FIG. 9, only the measurement signal 206 and the control signals 204 and 207 are electrical signals. All of the other signals shown in FIG. 9 are optical signals.

In the embodiment shown in FIG. 9, the plurality of VOAs, of which only three are shown 210A, 210B and 210C, the multiplexer 212, the 2×2 switch 216 and the 3-dB FC 188 form the selective combiner 52 of the selective add-channel system 50 shown in FIG. 1. In FIG. 9, the optical tap 214 and the OCM 198 represent the channel wavelength determiner 53 of FIG. 1.

Another example embodiment of a selective WDM add-channel system 305 is shown in FIG. 10. The selective WDM add-channel system 305 has an WDM input 218 to receive a WDM input signal, eight add-channel inputs to receive eight add-channel input signals, although only three add-channel inputs are shown 211, 213 and 215, and a WDM output 224 to transmit a WDM output signal.

At the instant depicted, optical signal transmitters TX₁, TX₅ and TX₈ are shown as being connected to the three add-channel inputs 211, 213 and 215 respectively. The WDM input 218 is connected to an input of a first optical tap 244, which is shown as a 5/95 FC optical tap in FIG. 10. The first optical tap 244 has a first output connected to a first input of an optical signal coupler 220, which is shown as a 3-dB FC in FIG. 10. The first optical tap 244 has a second output that is connected to a first input of a 2×1 switch 234. The optical signal coupler 220 has a second input connected to an output of an optical amplifier 226 and an output that is connected to the input of a second optical tap 246, which is also shown as a 5/95 FC optical tap in FIG. 10. The tap ratios of the first optical tap 244 and the second optical tap 246 are implementation specific details, as described above with reference to the optical tap 104 in FIG. 4. The second optical tap 246 has a first output that is connected to the WDM output 224 of the selective WDM add-channel system 305 and a second output that is connected to a second input of the 2×1 switch 234. The 2×1 switch 234 has an output that is connected to the signal input of a first OCM 236 and a control input that is connected to a control output 217 of a control logic block 242. Add channel inputs 211, 213 and 215 are connected to signal inputs of a plurality of 1×2 switches 240A, 240B and 240C respectively. Each of the plurality of 1×2 switches 240A, 240B and 240C has a first output connected to a signal input of a respective VOA 238A, 238B and 238C and a second output connected to a respective input of a first 8×1 combiner 230. The first 8×1 combiner 230 has an output that is connected to the signal input of a second OCM 232. The first OCM 236 and the second OCM 232 have measurement outputs which are connected to the control logic block 242 to send measurement signals 250 and 248 respectively to the control logic block 242. The control logic block 242 has a first plurality of control outputs 251 respectively connected to control inputs of the plurality of 1×2 switches 240A, 240B and 240C and a second plurality of control signals 249 respectively connected to the VOAs 238A, 238B and 238C. The VOAs 238A, 238B and 238C have signal outputs that are connected to respective inputs of a second 8×1 combiner 228. The second 8×1 combiner 228 has an output 235 connected to the input of the optical amplifier 226.

In some implementations, the optical amplifier 226 is not included and the output of the second 8×1 combiner 228 is connected to the second input of the optical signal coupler 220.

While the description of FIG. 10 describes a selective WDM add-channel system with eight add-channel inputs, in general, a selective WDM add-channel system according to the present invention may have any number of add-channel inputs. While the 8×1 combiners shown in FIG. 10 are limited to combining eight add-channel input signals, larger combiners or cascaded combiners could be used for a larger number of add-channel inputs.

In operation, an WDM signal input that includes one or more optical channels at different channel wavelengths is applied to the WDM input 218 of the selective WDM add-channel system 305. The control logic block 242 can monitor either the WDM input signal or the WDM output signal of the selective WDM add-channel system 305 by switching the 2×1 switch 234 such that either the second output of the first optical tap 244 or the second output of the second optical tap 246 is passed to the signal input of the first OCM 236 respectively. An add-channel optical signal that is to be added to the optical channels that are already part of the WDM signal input is applied to one of the add-channel inputs, for example, an add-channel signal may be applied to the add-channel input 215 by connecting the optical signal transmitter TX₈. The optical signal from the optical signal transmitter TX₈ would then be applied to the signal input of the 1×2 switch 240C. The control logic block 242 will set the 1×2 switch 240C such that the input of the 1×2 switch 240C, namely the optical signal generated by the optical signal transmitter TX₈, is switched to the respective input of the first 8×1 combiner 230, where it will be outputted to the second OCM 232 for measurement. The second OCM 232 measures the power levels and channel wavelengths of the output of the first 8×1 combiner and reports this measurement information to the control logic block 242. The control logic block 242 compares the channel wavelengths and power levels of the output of the first 8×1 combiner 230 to the channel wavelengths and power levels of one or both of the WDM input signal and the WDM output signal to determine if the optical signal generated by the optical signal transmitter TX₈ has the same channel wavelength as one of the other add-channel signals or the same channel wavelength as one of the channels included in the WDM input signal.

If, for example, the optical signal generated by the optical signal transmitter TX₈ is determined to have a different wavelength than the channels included in the WDM input signal and the WDM output signal, then the control logic 242 may set the 1×2 switch 240C such that the optical signal generated by the optical signal transmitter TX₈ is switched to the signal input of the VOA 238C. If the measurement of the power level of the optical signal by the second OCM 232 indicates that the power level of the optical signal is too high, the control logic block 242 may adjust the attenuation of the VOA 238C such that the power level of the optical signal at the output of the VOA 238C is reduced to a desired level. The desired level of the add-channel optical signals is an implementation specific detail and may depend on network requirements. Typically, if the add-channel optical signal is to be included in the WDM output 224, the control logic 242 will set the respective VOA to its minimum attenuation level (closed) so that the add-channel optical signal is passed to the second 8×1 combiner 228. The second 8×1 combiner 228 combines the add-channel optical signals applied to its inputs to produce a WDM add signal and outputs the WDM add signal to the optical amplifier 226, which amplifies the WDM add signal and passes the amplified WDM add signal to the second input of the optical signal coupler 220. The optical signal coupler 220 couples the amplified WDM add signal to the portion of the WDM input signal tapped off to the first output of the optical tap 244 and outputs these coupled signals to the input of the second optical tap 246, which taps off a portion of the coupled signals to produce the WDM output signal.

Alternatively, if, for example, the channel wavelength of the optical signal generated by the optical signal transmitter TX₈ is determined to be the same as the channel wavelength of one of the channels in either the WDM input signal or the WDM output signal, then the control logic 242 would set the 1×2 switch 240C such that the optical signal generated by the optical signal transmitter TX₈ is switched to the signal input of the VOA 238C, but in this case the control logic block 242 would set the VOA 238C to its maximum attenuation (open), thereby blocking the optical signal from being passed to the second 8×1 combiner 228 and combined with the WDM input signal.

Comparing new add-channel input optical signals to the WDM output 224 may be advantageous as the WDM output signal includes both the channels in the WDM input signal and any add-channel input optical signals that have previously been added to the WDM input signal to produce the WDM output signal.

In some implementations, only one of the optical taps 244 and 246 is provided and the 2×1 switch 234 is removed.

In some implementations, the add-channels are added all at once, while in other implementations, the add-channels may be added independently of one another.

In the embodiment shown in FIG. 10, only the measurement signals 248 and 250 and the control signals 217, 249 and 251 are electrical signals. All of the other signals shown in FIG. 10 are optical signals.

In the embodiment shown in FIG. 10, the plurality of VOAs, of which only three are shown 238A, 238B and 238C, the second 8×1 combiner 228 and the 3-dB FC 220 form the selective combiner 52 of the selective add-channel system 50 shown in FIG. 1. In FIG. 10, the plurality of 1×2 switches, of which only three are shown 240A, 240B and 240C, the first optical tap 244, the second optical tap 246, the first 8×1 combiner 230, the OCM 232, the 2×1 switch 234 and the OCM 236 represent the channel wavelength determiner 53 of FIG. 1.

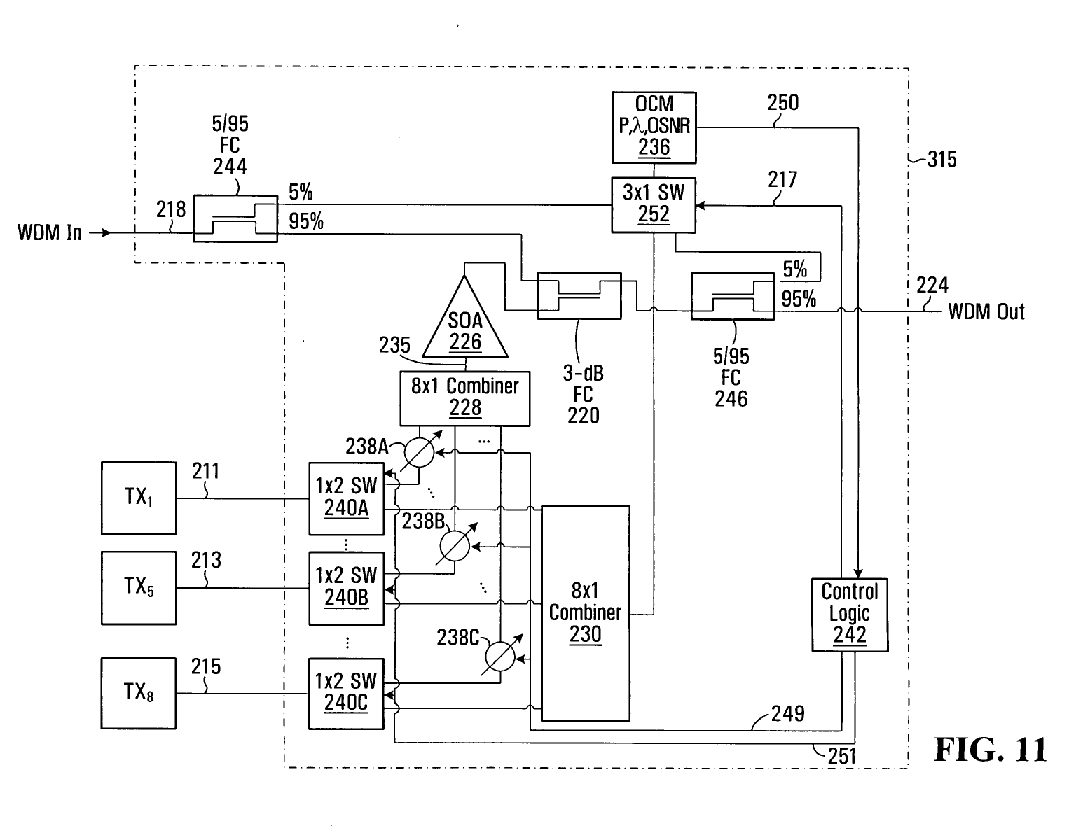

Another block diagram of an example embodiment of a selective WDM add-channel system 315 is shown in FIG. 11. The selective WDM add-channel system 315 shown in FIG. 11 is very similar to the selective WDM add-channel system 305 shown in FIG. 10, but the second OCM 232 has been removed and the 2×1 switch 234 has been replaced with a 3×1 switch 252. The output of the first 8×1 combiner has been connected to a third input on the 3×1 switch 252.

The operation of the selective WDM add-channel system 315 is very similar to the operation of the selective WDM add-channel system 305, except that all of the measurement is done by the first OCM 236 as the control logic block 242 uses the 3×1 switch 252 to select between measuring the WDM input 218, the WDM output 224 and the add-channel optical signals included in the output of the first 8×1 combiner 230.

In some implementations, only one of the optical taps 244 and 246 is provided, and the 3×1 switch 252 is replaced with a 2×1 switch.

In the embodiment shown in FIG. 11, the plurality of VOAs, of which only three are shown 238A, 238B and 238C, the second 8×1 combiner 228 and the 3-dB FC 220 form the selective combiner 52 of the selective add-channel system 50 shown in FIG. 1. In FIG. 11, the plurality of 1×2 switches, of which only three are shown 240A, 240B and 240C, the first optical tap 244, the second optical tap 246, the first 8×1 combiner 230, the 3×1 switch 252 and the OCM 236 represent the channel wavelength determiner 53 of FIG. 1.

In the embodiment shown in FIG. 11, only the measurement signal 250 and the control signals 217, 249 and 251 are electrical signals. All of the other signals shown in FIG. 11 are optical signals.

In the example embodiment shown in FIGS. 4 to 11 and describe above, OCMs have been provided to determine the power levels and channel wavelengths of optical signals. Optical channel monitors may be implemented with many different types of optical signal measurement devices, for example, spectrum analyzers, photodiodes and associated circuitry, to name a few examples.

In some implementations, the OCMs include tunable filters in order to scan through a band which includes all of the possible channel wavelengths.

In some implementations, optical channel monitors are used which are operable to determine the optical signal to noise ratio of an optical signal.

In some implementations, the WDM input signal of the selective WDM add-channel system includes “THROUGH” channels that were not dropped by an ADM drop-channel system.

In some implementations, the WDM input signal of the selective WDM add-channel system includes “EXPRESS” channels that were not droppable by an ADM drop-channel system.

In some implementations, the control logic block of the add-channel systems shown in FIGS. 1, 4 to 11 generates an alarm notification when an add-channel optical signal is blocked because it has the same channel wavelength as one of the channels included in the WDM input optical signal, the WDM output optical signal or one of the other add-channel optical signals.

In some implementations, the control logic block is connected to a display device so that status of the selective add-channel system, such as the details of alarm notifications and the power levels and channel wavelengths of the WDM input signal, the WDM output signal and the add-channel input signals, can be communicated to an operator of the selective add-channel system.

In FIGS. 4 to 11, the optical amplifiers 108, 136, 166, 194 and 226 are shown as being SOAs (semiconductor optical amplifiers), more generally any type of optical amplifier may be used, for example an EDFA (erbium doped fiber amplifier), Raman Amplifier, to name a few examples.

While the optical signal couplers 102, 130, 188 and 220 in FIGS. 4 to 7 and 9 to 11 are shown as being 3-dB FCs, more generally any optical signal coupler that is capable of coupling two WDM optical signals may be used, provided that the performance of the coupler satisfies implementation specific design requirements such as signal loss and bandwidth.

In some implementations, the control logic block 54, 114, 142, 172, 200 and 242 of FIGS. 1 and 4 to 11 is implemented as an application specific integrated circuit (ASIC) or in a logic device such as a field programmable gate array (FPGA) or a programmable logic device (PLD). In general, the control logic block might be implemented as hardware, software, firmware or combinations thereof, which are capable of implementing control logic.

While the embodiments described above relate to the add-channel system of an optical add-drop multiplexer, specifically a reconfigurable optical add-drop multiplexer, the present invention is not limited to these particular embodiments and may be applied to any optical system in which at least two optical signals are to be combined to produce an output signal.

What has been described is merely illustrative of the application of the principles of the invention. Other arrangements and methods can be implemented by those skilled in the art without departing from the spirit and scope of the present invention.

1. A method comprising:
determining a respective channel wavelength for each one of a plurality of add-channel input signals;
determining channel wavelengths of a WDM (wavelength division multiplex) input signal; and
selectively combining the plurality of add-channel input signals with the WDM input signal to produce a WDM output signal by, for each add-channel input signal:
a) blocking the add-channel input signal if the channel wavelength of the add-channel input signal is at least one of:
i) the same as the channel wavelength of any of the other add-channel input signals; and
ii) the same as any of the channel wavelengths of the WDM input signal; and
b) combining the add-channel input signal with the WDM input signal if the channel wavelength of the add-channel input signal is different than the channel wavelengths of the other add-channel input signals and the WDM input signal.

2. The method of claim 1, wherein determining the channel wavelengths of the WDM signal comprises:
determining channel wavelengths of the WDM output signal; and
determining the channel wavelengths of the WDM input signal from the channel wavelengths of the WDM output signal.

3. The method of claim 1, wherein selectively combining the add-channel input signals with the WDM input signal to produce the WDM output signal comprises:
selectively combining the add-channel input signals to produce a WDM add signal; and
combining the WDM add signal with the WDM input signal to produce the WDM output signal;
wherein selectively combining the add-channel input signals to produce the WDM add signal comprises:
for each add-channel input signal:
a) blocking the add-channel input signal from being added to the WDM add signal if the channel wavelength of the add-channel input signal is at least one of:
i) the same as the channel wavelength of any of the other add-channel input signals; and
ii) the same as any of the channel wavelengths of the WDM input signal; and
b) adding the add-channel input signal to the WDM add signal if the channel wavelength of the add-channel input signal is different than the channel wavelengths of the other add-channel input signals and the WDM input signal.

4. The method of claim 3, further comprising at least one of amplifying and gain flattening the WDM add signal.

5. The method of claim 1, wherein:
determining a respective channel wavelength for each one of a plurality of add-channel input signals comprises determining a respective channel power level for each one of the plurality of add-channel input signals; and
determining channel wavelengths of a WDM input signal comprises determining channel power levels of the WDM input signal.

6. The method of claim 5, wherein combining the add-channel input signal with the WDM input signal further comprises adjusting the respective channel power level of the add-channel input signal to be substantially equal to the channel power levels of the WDM input signal.

7. The method of claim 6, wherein blocking the add-channel input signal from being combined with the WDM input signal comprises attenuating the add-channel input signal.

8. The method of claim 1, wherein determining the channel wavelengths of the plurality of add-channel input signals comprises switching the add-channel input signals from first signal paths on which the add-channel input signals are any one of blocked and combined with the WDM input signal to second signal paths on which the channel wavelengths of the add-channel input signals are determined.

9. A selective combiner system comprising:
a plurality of add-channel inputs each operable to receive a respective one of a plurality of add-channel input signals;
a channel wavelength determiner operable to determine a respective channel wavelength for each of the plurality of add-channel input signals, and to determine channel wavelengths of a WDM signal with which the add-channel input signals are to be combined;
a selective combiner that for each add-channel input signal blocks the add-channel input signal or combines the add-channel input signal with the WDM signal; and
control logic functionally connected to control combining and blocking performed by the selective combiner so as to prevent adding multiple add-channel input signals having the same channel wavelength as each other, and so as to prevent adding an add-channel input signal having the same channel wavelength as any channel wavelength already present in the WDM signal.

10. The selective combiner system of claim 9 comprising:
a WDM input operable to receive a WDM input signal as said WDM signal;
the channel wavelength determiner operable to determine the channel wavelengths of the WDM signal with which the add-channel input signals are to be combined by processing the WDM input signal.

11. The selective combiner system of claim 9 comprising:
a WDM input operable to receive a WDM input signal as said WDM signal;
a WDM output operable to transmit a WDM output signal;
the channel wavelength determiner operable to determine the channel wavelengths of the WDM signal by processing the WDM output signal.

12. The selective combiner system of claim 9 wherein:
the selective combiner comprises a respective VOA for each add-channel input that performs said combining or blocking of the respective add-channel input signal.

13. The selective combiner system of claim 10 wherein the channel wavelength determiner comprises:
a respective OCM for each add-channel input;
an OCM for the WDM input signal.

14. The selective combiner system of claim 11 wherein the channel wavelength determiner comprises:
a respective OCM for each add-channel input;
an OCM for the WDM output signal.

15. The selective combiner system of claim 9 wherein the selective combiner comprises:
a first combiner that produces a WDM add signal that is a combination of add-channel signals that are not blocked;
a second combiner that combines the WDM add signal with the WDM signal to produce a combined WDM signal.

16. The selective combiner system of claim 15 wherein the first combiner comprises a fiber coupler cascade combiner.

17. The selective combiner system of claim 15 wherein the second combiner comprises a fiber coupler.

18. The selective combiner system of claim 15 further comprising:
an amplifier connected between the first combiner and the second combiner.

19. The selective combiner system of claim 18, wherein the amplifier comprises any one of an EDFA, an SOA and a Raman amplifier.

20. The selective combiner system of claim 15 further comprising:
a gain flattening element connected between the first combiner and the second combiner.

21. The selective combiner system of claim 9 further comprising:
a respective 1×2 switch for each add-channel input operable to switch the respective add-channel input signal between the selective combiner and the channel wavelength determiner.

22. The selective combiner system of claim 15 wherein the channel wavelength determiner comprises:
a first OCM for the combined WDM signal; and
a second OCM for the WDM signal.

23. The selective combiner system of claim 22 wherein the second combiner is operable to pass at least a portion of the combined WDM signal to the first OCM.

24. The selective combiner system of claim 15 further comprising:
a switch operable to: switch the WDM add signal between the second combiner and the channel wavelength determiner; and switch at least a portion of the WDM signal between the second combiner and the channel wavelength determiner.

25. The selective combiner system of claim 24 wherein the channel wavelength determiner comprises an OCM.

26. The selective combiner system of claim 21, wherein the channel wavelength determiner comprises:
a combiner operable to combine the respective add-channel input signals switched to the channel wavelength determiner to produce a combined output;
a first OCM for the combined output; and
a second OCM for the WDM signal.

27. The selective combiner system of claim 26 further comprising:
a WDM input operable to receive a WDM input signal as said WDM signal;
a WDM output operable to transmit a WDM output signal comprising a combination of add-channel input signals that are not blocked and the WDM signal;
wherein the channel wavelength determiner further comprises:
a 2×1 switch operable to switch any one of:
i) at least a portion of the WDM input signal; and
ii) at least a portion of the WDM output signal,
to the second OCM at a time.

28. The selective combiner system of claim 21, further comprising:
a WDM input operable to receive a WDM input signal as said WDM signal;
a WDM output operable to transmit a WDM output signal comprising a combination of add-channel input signals that are not blocked and the WDM signal;
wherein the channel wavelength determiner comprises:
an OCM;
a combiner operable to combine the respective add-channel input signals switched to the channel wavelength determiner to produce a combined output; and
a 3×1 switch operable to switch any one of:
i) at least a portion of the combined output;
ii) at least a portion of the WDM input signal; and
iii) at least a portion of the WDM output signal, to the OCM at a time.
